(19) United States
(12) Patent Application Publication
(10) Pub. No.: US 2025/0208530 A1
(43) Pub. Date: Jun. 26, 2025

(54) TONER

(71) Applicant: CANON KABUSHIKI KAISHA, Tokyo (JP)

(72) Inventors: KOSUKE FUKUDOME, Tokyo (JP); SHOHEI TSUDA, Shizuoka (JP); KAZUYUKI SATO, Kanagawa (JP); TORU ISHII, Shizuoka (JP); KENYA TERADA, Shizuoka (JP)

(21) Appl. No.: 18/988,145

(22) Filed: Dec. 19, 2024

(30) Foreign Application Priority Data
Dec. 26, 2023 (JP) 2023-219457
Dec. 2, 2024 (JP) 2024-209210

(51) Int. Cl. G03G 9/087; G03G 9/08; G03G 9/097

(52) U.S. Cl. CPC G03G 9/08755; G03G 9/0825; G03G 9/0827; G03G 9/09725; G03G 9/0975

(57) ABSTRACT

A toner includes a toner particle containing a binder resin, and an organic-inorganic composite fine particle. The binder resin contains 50% by mass or greater of polyester A, “Uᵢₛₒ/all acid components×100” indicating a content proportion of a unit Uᵢₛₒ derived from isophthalic acid in the polyester A is 60% by mole or greater with respect to an amount of all units derived from the acid components. The organic-inorganic composite fine particle has, on a surface of a resin particle, a plurality of protrusions derived from an inorganic fine particle. The inorganic fine particle includes a silica fine particle, and the resin particle contains an ester group.

### BACKGROUND

### Field

The present disclosure relates to a toner used in an electrophotographic image forming apparatus.

### Description of the Related Art

An electrophotographic image forming apparatus is required to speed up the process, be further miniaturized, and have a longer lifetime.

Therefore, there has been a demand for further improvement of various performances of a toner in order to realize the above-described requirements.

For example, there has been a demand for a toner having satisfactory low-temperature fixability (having an ability to be fixed to paper with a small heat quantity) in order to contribute to speed up the process of an electrophotographic apparatus and miniaturization thereof. This is because the process speed for sticking the toner to paper can be increased so that the speed-up can contribute to miniaturization of a fixing member.

Further, a one-component contact developing system that does not contain carrier particles charging the toner is suitably used from the viewpoint of reducing the number of components in order to contribute to miniaturization, but the toner and a photoreceptor are continuously in contact with each other for a long time when this developing system is used, and thus a toner that is unlikely to cause toner deterioration or member contamination and has high durability is required.

Further, printers recently have begun to be used in offices with double-sided printing set as a normal mode from the viewpoint of efficiently applying paper resources. In a case where double-sided printing is set as a normal mode, since printed materials are obtained by forming twice as many images when the same number of sheets of printed materials are obtained, the chances of the toner coming into contact with other components are increased, and thus this method is susceptible to toner deterioration and member contamination. Therefore, there has been a demand for an image forming apparatus with a longer lifetime.

Under the above-described circumstances, the requirement for improving low-temperature fixability and durability of a toner has been increasing more than ever, but the durability of a toner with satisfactory low-temperature fixability tends to be degraded, and thus achievement of both the low-temperature fixability and the durability has been a disadvantage in some cases. For example, Japanese Patent Laid-Open No. 2019-049629 suggests that, as a method of improving the low-temperature fixability of a toner, an offset of a solid image to other images can be improved by using a toner that contains a polyester resin having a unit derived from isophthalic acid as a binder resin.

Meanwhile, for example, PCT Japanese Translation Patent Publication No. 2015-502567 suggests that in a case of endurable use of a toner containing organic-inorganic composite fine particles, the durability of the toner can be enhanced by suppressing the organic-inorganic composite fine particles from being embedded in the surface or being transferred from the toner.

Further, Japanese Patent Laid-Open No. 2021-193419 suggests that a toner contains polyester having an isophthalic acid unit as an extremely small portion of a binder resin and contains organic-inorganic composite fine particles as an external additive.

As a result of examination conducted by the present inventors, the toner described in Japanese Patent Laid-Open No. 2019-049629 is found to have a certain degree of effect on improving the low-temperature fixability when a toner that contains, as a binder resin, a polyester resin having a unit derived from isophthalic acid is used as the toner. However, in a case where an image forming apparatus that employs a one-component developing system is used such that double-sided images are output at a high frequency in a low-temperature and low-humidity environment, a conductive member is contaminated by an external additive of the toner in long-term use, and thus unevenness occurs in a halftone image in some cases.

Further, the toner described in PCT Japanese Translation Patent Publication No. 2015-502567 certainly has an effect of improving the durability of the toner, but in a case where double-sided images are output at a high frequency using the toner in a low-temperature and low-humidity environment in an image forming apparatus that employs a one-component developing system, which requires the toner to have higher durability, the organic-inorganic composite fine particles contaminate other members, and thus there is a limit in designing a longer lifetime. Further, there is also room for improvement in terms of low-temperature fixability (abrasion density-decreasing rate) of a halftone image in a low-temperature and low-humidity environment.

The toner described in Japanese Patent Laid-Open No. 2021-193419 contains polyester having a unit derived from isophthalic acid, but improvement of the low-temperature fixability is insufficient. Further, in the image forming apparatus employing a one-component developing system, which is used such that double-sided images are output at a high frequency in a low-temperature and low-humidity environment, the organic-inorganic composite fine particles contaminate a charging member, and thus unevenness may occur in the halftone image in long-term use.

In addition, none of the above-described documents including examples describes image formation in a double-sided printing mode which is susceptible to contamination.

### SUMMARY

The present disclosure provides a toner that has overcome the above-described disadvantages. Specifically, the present disclosure provides a toner that has satisfactory low-temperature fixability and enables a charging member to have satisfactory anti-contamination properties, which is a toner that enables a charging member to have satisfactory anti-contamination properties using an external additive of the toner and is capable of outputting a highly uniform halftone image even in a case where an image forming apparatus employing a one-component developing system is used such that double-sided images are output at a high frequency in a low-temperature and low-humidity environment.

The present inventors have conducted intensive examination on the low-temperature fixability of the toner and the anti-contamination properties of the charging member in order to address the above-described disadvantages.

As a result, it has been found that only in a case where toner particles contain a specific amount or greater of polyester A having a unit derived from a certain amount of isophthalic acid and the toner contains organic-inorganic composite fine particles having a specific shape and a specific composition, both the low-temperature fixability (abrasion density-decreasing rate) of a halftone image in a low-temperature and low-humidity environment and the anti-contamination properties of a charging roller (halftone density uniformity) after endurance of double-sided printing in a low-temperature and low-humidity environment can be achieved.

That is, according to the present disclosure, there is provided a toner including: a toner particle that contains a binder resin; and an organic-inorganic composite fine particle, in which the binder resin contains 50% by mass or greater of polyester A, a content proportion of a unit Uᵢₛₒ derived from isophthalic acid in the polyester A is 60% by mole or greater with respect to an amount of all units derived from an acid component, the organic-inorganic composite fine particle has, on a surface of a resin particle, a plurality of protrusions derived from an inorganic fine particle, the inorganic fine particle includes a silica fine particle, and the resin particle contains an ester group.

Further features of the present disclosure will become apparent from the following description of exemplary embodiments.

### DESCRIPTION OF THE EMBODIMENTS

Further, in the present disclosure, the description of a numerical range of “XX or greater and YY or less” or “XX to YY” denotes a numerical range including the endpoints as the lower limit and the upper limit unless otherwise specified. In a case where numerical ranges are described in a stepwise manner, the upper limits and the lower limits of each of the numerical ranges can be used in any combination.

### Features of Present Disclosure

As described above, it is effective to allow toner particles to contain polyester having a large amount of units derived from isophthalic acid as a main component of a binder resin, as a method of improving low-temperature fixability (abrasion density-decreasing rate) of a halftone image in a low-temperature and low-humidity environment. However, it has been found that in a case where an image forming apparatus employing a one-component contact developing system is used such that double-sided images are output at a high frequency in a low-temperature and low-humidity environment, an external additive is transferred to a photoreceptor from the surface of the toner particles, and the transferred external additive contaminates a charging member (charging roller).

As described above, since the toner and the photoreceptor are in contact with each other for a long period of time, the one-component contact developing system is a system susceptible to toner deterioration and transfer of the external additive to other members. Further, the printing mode in which double-sided images are output at a high frequency is also a mode susceptible to toner deterioration and transferability of the external additive due to an increase in time for forming images.

Further, as a result of examination conducted by the present inventors, it has been found that the external additive is likely to be transferred from the toner particles to the photoreceptor due to an increase in frictional sliding force applied to the toner caused by an increase in charge amount of the toner and hardening of the photoreceptor or a developing roller particularly in a low-temperature and low-humidity environment.

Therefore, it has been found that in a case where an image forming apparatus employing a one-component contact developing system is used such that double-sided images are output at a high frequency in a low-temperature and low-humidity environment, the external additive is accumulated on the charging member in long-term use, and thus density unevenness occurs in a halftone image.

Further, as a result of detailed examination conducted by the present inventors, it has also been found that in a case where the toner particles contain, as a binder resin, polyester having a unit derived from isophthalic acid, silica fine particles are likely to be transferred to the photoreceptor from the surface of the toner particles as compared with a case where the toner particles contain polyester having only a unit derived from terephthalic acid.

The reason for this is not clear, but it is assumed that since oxygen atoms of a carbonyl group bonded to a benzene ring are likely to be aligned, the unit derived from isophthalic acid has a microscope region with a large amount of an electric charge (microscopic negative region), and thus the external additive is likely to be transferred to the photoreceptor due to an electrostatic repulsive force between the microscopic negative region and the highly negative external additive, such as silica.

Therefore, the present inventors have conducted intensive examination on a method of suppressing the transfer of the external additive to the photoreceptor in a case where the toner particles contain, as a main binder resin component, polyester having a large amount of units derived from isophthalic acid. As a result, it has been found that both the low-temperature fixability (abrasion density-decreasing rate) of a halftone image in a low-temperature and low-humidity environment and the anti-contamination properties of the charging roller (halftone density uniformity) after endurance of double-sided printing in a low-temperature and low-humidity environment can be achieved by allowing the toner to contain specific organic-inorganic composite fine particles, thereby completing the present disclosure.

That is, the present disclosure provides a toner including a toner particle that contains a binder resin, and an organic-inorganic composite fine particle, in which the binder resin contains 50% by mass or greater of polyester A, a content proportion of a unit Uᵢₛₒ derived from isophthalic acid in the polyester A is 60% by mole or greater with respect to an amount of all units derived from an acid component, the organic-inorganic composite fine particle has, on a surface of a resin particle, a plurality of protrusions derived from an inorganic fine particle, the inorganic fine particle includes a silica fine particle, and the resin particle contains an ester group. Further, the content proportion of the unit Uᵢₛₒ with respect to the amount of all units derived from the acid component is a value calculated by the following equation.

Content proportion (mole %) of unit Uᵢₛₒ=(number of units Uᵢₛₒ/number of units of all acid components)×100

With the above-described configuration, it is considered that the anti-contamination properties of the charging member can be enhanced by the following mechanism. The organic-inorganic composite fine particles include silica fine particles forming protrusions and resin particles, and the resin particles contain an ester group. The carbon atom positioned at the center of a COO bond of the ester group is considered to be a microscopic region with a small electric charge (microscopic positive region), which is less likely to attract the electric charge compared to oxygen atoms and silica fine particles in the periphery thereof.

Meanwhile, the toner particles contain a specific amount of the polyester A having a specific amount of units derived from isophthalic acid and thus have a plurality of microscopic negative regions formed of the units derived from isophthalic acid.

In this manner, since an electrostatic adhesive force is generated between the microscopic positive region of the organic-inorganic composite fine particles and the microscopic negative region of the toner particles, the organic-inorganic composite fine particles are unlikely to be transferred to the photoreceptor from the toner particles even in long-term endurance use, and the anti-contamination properties of the charging member are enhanced.

Hereinafter, each constituent element of the present disclosure will be described in detail.

The toner of the present disclosure includes toner particles containing a binder resin.

The binder resin contains 50% by mass or greater of the polyester A, and the polyester A is required to be formed such that the content proportion of the unit Uᵢₛₒ derived from isophthalic acid is 60% by mole or greater with respect to the amount of all units derived from an acid component. In this manner, the low-temperature fixability (abrasion density-decreasing rate) of a halftone image in a low-temperature and low-humidity environment is enhanced, and further the anti-contamination properties of the charging member are enhanced even when an endurance test is performed in a double-sided printing mode in a one-component contact developing system. Therefore, the density uniformity of the halftone image is enhanced.

The content proportion of the unit Uᵢₛₒ in the polyester A is preferably 90% by mole or greater with respect to the amount of all units derived from an acid component.

The organic-inorganic composite fine particles are required to have, on the surface of resin particles, a plurality of protrusions derived from inorganic fine particles. When an anchor effect is exhibited by the protrusions, a toner in which organic-inorganic composite fine particles are unlikely to be embedded in the surface of the toner particles even in an environment where embedding of an external additive is likely to occur, such as a high-temperature and high-humidity environment, and fogging after endurance of double-sided printing in a high-temperature and high-humidity environment is small can be obtained.

The organic-inorganic composite fine particles are required to include silica fine particles as inorganic fine particles. When the organic-inorganic composite fine particles include the silica fine particles, the organic-inorganic composite fine particles have negativity as the entirety of the particles. Further, in a case where the silica fine particles form protrusions of the organic-inorganic composite fine particles, the protrusions are triboelectrically charged with a charge imparting member such as a developing roller or a developing blade, and thus the entirety of the organic-inorganic composite fine particles is likely to be negatively charged.

The resin particles of the organic-inorganic composite fine particles are required to contain an ester group. Only when the resin particles contain an ester group, the resin particles have a microscopic region with a small amount of electric charge (microscopic positive region)) as described above. In this manner, since an electrostatic adhesive force is generated between the microscopic positive region of the organic-inorganic composite fine particles and the microscopic negative region of the toner particles, the organic-inorganic composite fine particles are unlikely to be transferred to other members from the toner particles even in long-term endurance use in a low-temperature and low-humidity environment. Accordingly, the anti-contamination properties of the charging member are enhanced, and the density uniformity of a halftone image after endurance of double-sided printing in a low-temperature and low-humidity environment is increased.

The polyester A has a unit U_{EO} derived from an ethylene oxide adduct of bisphenol A and a unit U_{PO} derived from a propylene oxide adduct of bisphenol A, and the total content proportion of the unit UFO and the unit U_{PO} is preferably 90% by mole or greater with respect to the amount of all units derived from an alcohol component. Since the ethylene oxide adduct of bisphenol A and the propylene oxide adduct of bisphenol A have a property of easily plasticized by wax or crystalline polyester contained in the toner particles when heated an melted during fixation, in a case where the content of units is in the above-described ranges, the binder resin is plasticized and likely to soak into fibers of paper when the ethylene oxide adduct and the propylene oxide adduct are heated and melted during fixation. Therefore, the adhesiveness of the toner to paper is further increased, and the folding resistance of an image is enhanced even at a lower fixing temperature. Specifically, the folding resistance of a line image in a low-temperature and low-humidity environment is enhanced.

Further, the content proportion of the unit UFO is preferably 15% by mole or greater and 40% by mole or less with respect to the total content proportion of the unit U_{EO} and the unit U_{PO}. In addition, the content proportion of the unit U_{EO} discussed here is a value calculated by the following equation.

Content proportion (mole %) of unit U_{EO}=(number of units U_{EO}/number of units U_{EO} and units U_{PO})×100

The unit U_{PO} is a bisphenol A unit which has a larger number of carbon atoms and to which propylene oxide having a branched structure is added as compared with the unit U_{EO}. Therefore, the unit U_{PO} has a property of having higher hydrophobicity and a lower intermolecular force as compared with the unit U_{EO}. Conversely, the unit U_{EO} has a property of having lower hydrophobicity and a higher intermolecular force as compared with the unit U_{PO}.

In a case where the content proportion of the unit U_{EO} is 15% by mole or greater, since the intermolecular force of the polyester A increases, deformation of the polyester A in a high-temperature and high-humidity environment tends to be suppressed. Meanwhile, in a case where the content proportion of the unit U_{EO} is 40% by mole or less, since the hydrophobicity of the polyester A increases, the amount of moisture adsorption of the polyester A in aa high-temperature and high-humidity environment is not excessively high. The content proportion of the unit U_{EO} is preferably 15% by mole or greater and 40% by mole or less due to these effects from the viewpoint that the durability of the toner in a high-temperature and high-humidity environment is enhanced and that fogging of a non-image area after endurance of double-sided printing in a high-temperature and high-humidity environment can be suppressed.

When the number average molecular weight (Mn) and the weight-average molecular weight (Mw) of tetrahydrofuran (THF) soluble matter of the polyester A are measured using gel permeation chromatography (GPC), the number average molecular weight (Mn) is preferably 3,000 or greater and 10,000 or less, and the ratio (Mw/Mn) is preferably 2.5 or greater.

The number average molecular weight (Mn) thereof is preferably 3,000 or greater from the viewpoint that the durability of the toner in a high-temperature and high-humidity environment is enhanced and that fogging of a non-image area after endurance of double-sided printing in a high-temperature and high-humidity environment can be suppressed. Meanwhile, the number average molecular weight (Mn) thereof is preferably 10,000 or less from the viewpoint that melt flowability of the binder resin during fixation increases and thus the binder resin is likely to soak into fibers of paper, the adhesiveness to paper increases, and the durability to folding of an image is enhanced. The number average molecular weight (Mn) thereof is more preferably 4,000 or greater and 8,000 or less.

Further, when the ratio Mw/Mn is 2.5 or greater, this indicates that the molecular weight distribution of the polyester A is sufficiently wide, entanglement sufficiently occurs between molecular chains of the polyester A so that the toner particles have sufficient hardness even in a high-temperature and high-humidity environment, the durability of the toner is enhanced, and fogging of a non-image area can be suppressed. The ratio Mw/Mn is more preferably 3.2 or greater and still more preferably 3.7 or greater.

From the viewpoint of obtaining a toner in which the low-temperature fixability (abrasion density-decreasing rate) of a halftone image in a low-temperature and low-humidity environment is satisfactory, the binder resin may further contain crystalline polyester. Suitable examples of polyester as the crystalline polyester will be described below.

The average circularity of the toner particles is preferably 0.950 or greater and 0.980 or less from the viewpoint that the transferability is enhanced in a wide range of environment and that a satisfactory image can be obtained even in long-term endurance use. Specifically, the average circularity thereof is preferably 0.950 or greater from the viewpoint that non-electrostatic adhesive force between the toner particles does not excessively increase even in a case of long-term endurance use in a high-temperature and high-humidity environment so that satisfactory transferability can be maintained, and thus the uniformity of a solid image in a high-temperature and high-humidity environment is enhanced.

Meanwhile, the average circularity thereof is preferably 0.980 or less from the viewpoint that the non-electrostatic adhesive force is moderate between the toner particles even in a low-temperature and low-humidity environment where the non-electrostatic adhesive force between the toner particles is likely to be decreased, scattering of the toner in a transferring step can be suppressed, and thus dot reproducibility of a halftone image in a low-temperature and low-humidity environment is enhanced. The average circularity of the toner particles is more preferably 0.955 or greater and 0.975 or less.

A method of producing a chemical toner, such as an emulsion aggregation method, a suspension polymerization method, or a suspension granulation method, can be employed as a method of producing a toner in order to adjust the average circularity of the toner to be in a suitable range of the present disclosure. Further, in a case where an emulsion aggregation method is used, the circularity can be adjusted by providing a spheronization step in order to obtain a surface shape of a desired toner. In a case where a pulverization method is used, the circularity of the toner can also be adjusted by performing a surface treatment, which is a thermal spheronization treatment, using hot air.

A number average particle diameter (D1) of the organic-inorganic composite fine particles is preferably 50 nm or greater and 200 nm or less, and a shape factor SF-2 thereof as measured at a magnification of 200,000 times is preferably 103 or greater and 120 or less. The shape factor SF-2 is an index of the degree of unevenness of particles, the surface shape is a perfect circle when the value thereof is 100, and the degree of unevenness increases when the numerical value thereof increases. The number average particle diameter D1 of the organic-inorganic composite fine particles is preferably 200 nm or less and the shape factor SF-2 thereof is preferably 103 or greater from the viewpoint that the organic-inorganic composite fine particles are likely to be fixed to the surface of the toner particles and the organic-inorganic composite fine particles are unlikely to be transferred to other members.

In this manner, occurrence of streak-like unevenness on a halftone image can be suppressed even in a special image output mode, such as a mode in which high print images are continuously printed in a low-temperature and low-humidity environment. In this manner, streaks on a halftone image can be satisfactorily suppressed after endurance of continuously printing solid images in a low-temperature and low-humidity environment. Further, even when images are printed for a long period of time in a mode in which streak-like contamination of the charging member is likely to be caused by the external additive, contamination of the charging member can be reduced, and occurrence of streak-like unevenness on a halftone image can be suppressed. The reason why streak-like unevenness is likely to occur in a case where high print images are continuously output is assumed to be that the external additive is transferred to the charging member in a shorter time compared with a case of normal print images, and thus deviation of the contamination state is likely to occur during the accumulation process. The number average particle diameter D1 is more preferably 185 nm or less, and the shape factor SF-2 is more preferably 105 or greater.

Meanwhile, the number average particle diameter D1 is preferably 50 nm or greater and the shape factor SF-2 is preferably 120 or less from the viewpoint that the organic-inorganic composite fine particles are unlikely to be embedded to the surface of the toner particles in a high-temperature and high-humidity environment, and fogging to a non-image area after endurance of double-sided printing in a high-temperature and high-humidity environment can be suppressed. The number average particle diameter D1 is more preferably 53 nm or greater, and the shape factor SF-2 is more preferably 117 or less.

A ratio P2/P1 of an intensity P2 of a peak derived from C═O to an intensity P1 of a peak derived from Si—O, which is obtained by ATR-IR measurement of the organic-inorganic composite fine particles, is preferably 0.05 or greater and 0.15 or less from the viewpoint that the anti-contamination properties of the charging member are further enhanced, and a satisfactory halftone image can be obtained even in a case where various images are output in a special output mode for a long period of time.

P1 is the peak intensity derived from Si—O and thus is an index of an abundance of silica particles contained in the organic-inorganic composite fine particles. Meanwhile, P2 is the peak intensity derived from C═O and thus is an index of an abundance of an ester group in the resin particles contained in the organic-inorganic composite fine particles. Therefore, the ratio P2/P1 is a relative index of the abundance ratio of the silica particles to the ester group in the resin particles contained in the organic-inorganic composite fine particles.

The ratio P2/P1 can be controlled by controlling the kind of monomer forming the resin particles, the mixing ratio of the monomer, and the mass ratio between the monomer forming the resin particles and a silica dispersion liquid.

The ratio P2/P1 of the organic-inorganic composite fine particles is preferably 0.05 or greater from the viewpoint that since the resin particles contain a sufficient amount of the ester group with respect to the negative silica particles, the electrostatic adhesive force between the microscopic positive region of the ester group and the microscopic negative region of the polyester A is strengthened, and thus the organic-inorganic composite fine particles are unlikely to be transferred to the photoreceptor from the toner particles in a more severe use environment. Therefore, even in a case where images are printed for a long period of time in a special image pattern, such as continuous output of vertical band images, in which the charging member is likely to be contaminated in the form of longitudinal unevenness, the density unevenness of a halftone image can be suppressed, and thus the halftone density uniformity after endurance of double-sided printing of vertical band images in a low-temperature and low-humidity environment is enhanced.

Meanwhile, when the ratio P2/P1 is 0.15 or less, the organic-inorganic composite fine particles have a sufficient amount of silica particles with respect to the amount of the ester group contained in the resin particles so that the organic-inorganic composite fine particles have high negativity. Therefore, charge rising properties are enhanced even in a low-temperature and low-humidity environment where the charge rising properties of the toner are difficult to achieve. Accordingly, the density uniformity of a halftone area can be enhanced even in a case where printing is performed in an image pattern (black background area followed by a ghost image having a halftone area) susceptible to occurrence of image unevenness when the charge rising properties are poor after endurance of double-sided printing in a low-temperature and low-humidity environment.

A surface exposure rate B of silica in the organic-inorganic composite fine particles as measured by X-ray photoelectron spectroscopic analysis is preferably 45% or greater and more preferably 50% or greater. When the surface exposure rate B thereof is in the above-described ranges, the negativity of silica in the organic-inorganic composite fine particles is increased, and fogging to a non-image area can be suppressed even in a case where an image forming apparatus is used in a high-temperature and high-humidity environment for a long period of time, allowed to stand for a long period of time, and then used.

A value obtained by dividing the ratio P2/P1 of the toner by the content proportion of Uᵢₛₒ with respect to the amount of all units derived from an acid component and multiplying the obtained value by 100 is preferably 0.05 or greater.

The ratio P2/P1 is a relative index of the abundance ratio between the silica particles in the organic-inorganic composite fine particles and the ester group in the resin particles as described above. Meanwhile, the content proportion of Uᵢₛₒ with respect to the amount of all units derived from an acid component is an abundance ratio of the unit derived from isophthalic acid with respect to all acid components.

In the toner of the present disclosure, in a case where a value obtained by dividing the ratio P2/P1 by Uᵢₛₒ/all acid components×100 and multiplying the obtained value by 100 is 0.05 or greater, the electrostatic adhesive force between the organic-inorganic composite fine particles and the polyester A is further increased. Therefore, the anti-contamination properties of the charging member are excellent even in a case of long-term endurance use in an extremely low-temperature and low-humidity environment, which is an environment more susceptible to transfer of the external additive to other members, and the density uniformity of a halftone image after endurance of double-sided printing in an extremely low-temperature and low-humidity environment is enhanced.

In a case where an intensity P3 of a peak derived from a styrene unit and an intensity P2 of a peak derived from C═O are obtained in ATR-IR measurement of the organic-inorganic composite fine particles, the ratio (P2/P3) is preferably 1.0 or greater. In this manner, a specific amount or greater of an ester group unit with respect to the amount of the styrene unit is present in the resin particles contained in the organic-inorganic composite fine particles. When a specific amount or greater of the ester group is contained in the resin particles, since the resin particles moderately bear the moisture even in a low-temperature and low-humidity environment, the electric charge applied from the outside to the organic-inorganic composite fine particles can be made uniform, and thus the charge distribution of the toner is enhanced. Therefore, line width uniformity after endurance of double-sided printing can be enhanced in a low-temperature and low-humidity environment. The ratio P2/P3 is more preferably 2.0 or greater and still more preferably 3.35 or greater.

The upper limit of the ratio P2/P3 is not particularly limited, but is preferably 10.0 or less from the viewpoint that the chargeability of the toner in a high-temperature and high-humidity environment is enhanced.

The P2/P3 can be controlled by controlling the kind of monomer forming the resin particles and the mixing ratio of the monomer.

The amount of an aluminum element in the toner particles is preferably 0.015% by mass or greater and 0.150% by mass or less from the viewpoint that the line width uniformity of a thin vertical line image in a low-temperature and low-humidity environment is enhanced. The reason why this effect can be obtained is not clear, but it is assumed that in a case where the amount of the aluminum element is in the above-described range, aluminum has a crosslinked structure in the toner particles so that the toner has moderate elasticity even in a low-temperature and low humidity environment, and thus the toner can be uniformly stacked on paper.

A method of allowing the toner particles to contain an aluminum element is not particularly limited, and the toner particles to be obtained may contain an aluminum element by using a compound containing an aluminum element in any of the steps of producing the toner particles.

For example, a method of adding a compound containing an aluminum element as a material constituting the toner particles or a method of allowing the toner particles to be obtained to contain an aluminum element by using an aggregating agent containing an aluminum element as an aggregating agent used in an aggregation step in a case of producing the toner particles using an emulsion aggregation method may be used. The content of the aluminum element of the toner particles can be calculated by the method described in examples.

In a case where the toner contains alkylbenzenesulfonic acid and/or an alkylbenzene sulfonate, the line width uniformity of a thin vertical line image in a high-temperature and high-humidity environment can be enhanced.

The reason why this effect can be obtained is not clear, but is assumed that since the uniformity of the electric charge in the toner surface is increased due to an interaction between the alkylbenzenesulfonic acid and/or the alkylbenzene sulfonate and moisture, even a thin vertical line image can be developed and transferred faithfully to a latent image.

From the viewpoint of satisfactory line width uniformity of a thin line image vertical in a higher-temperature and higher-humidity environment, the alkyl group of the alkylbenzenesulfonic acid and/or the alkylbenzene sulfonate is preferably linear and more preferably has 10 to 14 carbon atoms. Specific suitable examples of the aspect thereof include decylbenzenesulfonic acid and/or a salt thereof (10 carbon atoms), undecylbenzenesulfonic acid and/or a salt thereof (11 carbon atoms), dodecylbenzenesulfonic acid and/or a salt thereof (12 carbon atoms), and tetradecylbenzenesulfonic acid and/or a salt thereof (14 carbon atoms).

Further, a metal constituting the alkylbenzene sulfonate may be a monovalent or divalent metal, and examples thereof include sodium, potassium, magnesium, and calcium. From the viewpoint that the line width uniformity of a thin vertical line image in a higher temperature and higher humidity environment is enhanced, a monovalent metal is suitable, and sodium is more suitable. Specifically, sodium decylbenzene sulfonate (10 carbon atoms), sodium undecylbenzene sulfonate (11 carbon atoms), sodium dodecylbenzene sulfonate (12 carbon atoms), or sodium tetradecylbenzene sulfonate (14 carbon atoms) is suitable, and sodium dodecylbenzene sulfonate is particularly suitable.

A method of allowing the toner to contain alkylbenzenesulfonic acid and/or an alkylbenzene sulfonate is not limited, and the toner to be obtained may contain an alkylbenzene sulfonate by using a compound containing alkylbenzenesulfonic acid and/or an alkylbenzene sulfonate in any of the steps of producing the toner.

For example, a method of adding a compound containing alkylbenzenesulfonic acid and/or an alkylbenzene sulfonate as a material constituting the toner or a method of allowing the toner to be obtained to contain an alkylbenzene sulfonate by using alkylbenzenesulfonic acid and/or an alkylbenzene sulfonate as a surfactant when a dispersion liquid such as a resin fine particle dispersion liquid, a colorant particle dispersion liquid, or a release agent particle dispersion liquid is prepared in a case where the toner is produced by an emulsion aggregation method may be used.

Whether or not the toner contains alkylbenzenesulfonic acid and/or an alkylbenzene sulfonate can be determined by the method described in the examples. Further, the content (on a mass basis) of the alkylbenzenesulfonic acid or the alkylbenzene sulfonate is preferably 10 ppm or greater and 1,000 ppm or less.

### Suitable Aspects of Toner Particles

Next, suitable constituent components and aspects of the toner particles according to the present embodiment will be described.

### Binder Resin

The toner particles contain a binder resin. The content of the binder resin is preferably 50% by mass or greater with respect to the total amount of the resin component in the toner particles.

The binder resin is required to contain 50% by mass or greater of the polyester A as described above and preferably 70% by mass or greater of the polyester A from the viewpoint that the anti-contamination properties of the charging roller (halftone density uniformity) after endurance of double-sided printing in a lower temperature and lower humidity environment are enhanced, and the low-temperature fixability (abrasion density-decreasing rate) of a halftone image in a low-temperature and low-humidity environment is also enhanced.

Further, the binder resin may contain polyesters other than the polyester A, such as a styrene acrylic resin, an epoxy resin, a polyester resin, a polyurethane resin, a polyamide resin, a cellulose resin, a polyether resin, and mixed resins and composite resins thereof.

### Polyester A

As described above, the content proportion of the unit Uᵢₛₒ derived from isophthalic acid in the polyester A is required to be 60% by mole or greater and preferably 90% by mole or greater with respect to the amount of all units derived from an acid component.

The polyester A used in the toner particles can be amorphous polyester. The unit derived from isophthalic acid may be used as an essential component, and examples thereof include the followings.

The polyester can be obtained by selecting suitable ones from among a polycarboxylic acid, a polyol, and a hydroxycarboxylic acid, combining these, and synthesizing these using a known method such as a transesterification method or a polycondensation method. The polyester can contain a condensation polymer of a dicarboxylic acid and a diol.

The polycarboxylic acid is a compound containing two or more carboxy groups in a molecule. Among examples of the polycarboxylic acid, a dicarboxylic acid is a compound containing two carboxy groups in one molecule and is suitably used. Examples of the dicarboxylic acid include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Further, examples of the polycarboxylic acid other than the dicarboxylic acid include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. There may be used alone or in combination of two or more kinds thereof.

The polyol is a compound containing two or more hydroxyl groups in one molecule. Among examples of the polyol, the diol is a compound containing two hydroxyl groups in one molecule, and is suitably used.

Specific examples of the polyol include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, and butylene oxide) adducts of the above-described bisphenols.

Among these, alkylene glycol having 2 or more and 12 or less carbon atoms and alkylene oxide adducts of bisphenols are suitable, and combinations of alkylene oxide adducts of bisphenols and alkylene glycol having 2 or more and 12 or less carbon atoms are particularly suitable. Examples of the alkylene oxide adduct of bisphenol A include compounds represented by Formula (A).

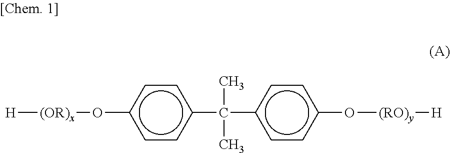

(In Formula (A), R's each independently represent an ethylene group or a propylene group, x and y each represent an integer of 0 or greater, and an average value of x+y is 0 or greater and 10 or less.)

The alkylene oxide adduct of bisphenol A is suitably a propylene oxide adduct and/or an ethylene oxide adduct of bisphenol A and more suitably a propylene oxide adduct. Further, the average value of x+y is preferably 1 or greater and 5 or less.

Examples of the tri- or higher hydric alcohol include glycerin, trimethylolethane, trimethylolpropane, pentaerythritol, hexamethylolmelamine, hexaethylolmelamine, tetramethylol benzoguanamine, tetraethylol benzoguanamine, sorbitol, trisphenol PA, phenol novolac, cresol novolac, and alkylene oxide adducts of the above-described tri- or higher valent polyphenols. These may be used alone or in combination of two or more kinds thereof.

The acid value of the polyester A is preferably 4.0 mgKOH/g or greater and 10.0 mgKOH/g or less.

### Release Agent

In the present disclosure, the toner can contain a known release agent.

Specific examples thereof include petroleum-based waxes such as paraffin wax, microcrystalline wax, and petrolatum, and derivatives thereof, montan waxes and derivatives thereof, hydrocarbon waxes obtained by using the Fischer-Tropsch method and derivatives thereof, polyolefin waxes such as polyethylene and derivatives thereof, and natural waxes such as carnauba wax and candelilla wax and derivatives thereof, and the derivatives include oxides, block copolymers with vinyl monomers, and graft modified products.

Further, examples of the waxes include alcohols such as higher aliphatic alcohol; fatty acids such as stearic acid and palmitic acid, acid amides, esters, and ketones thereof; hydrogenated castor oil and derivatives thereof, vegetable waxes, and animal waxes. These may be used alone or in combination

Among these, polyolefin, hydrocarbon wax obtained by using the Fischer-Tropsch method, or petroleum-based wax can be used from the viewpoint that the developability and the transferability tend to be improved. Further, an antioxidant may be added to these waxes in a range where the effects of the toner are not affected. Further, from the viewpoints of the phase separation properties with respect to the binder resin and the crystallization temperature, suitable examples thereof include higher fatty acid esters such as behenyl behenate and dibehenyl sebacate.

The content of the release agent is preferably 1.0 parts by mass or greater and 30.0 parts by mass or less with respect to 100.0 parts by mass of the binder resin.

The melting point of the release agent is preferably 30° C. or higher and 120° C. or lower and more preferably 60° C. or higher and 100° C. or lower. In a case where a release agent exhibiting the above-described thermal properties is used, a release effect is efficiently exhibited, and a wider fixing region is ensured.

### Plasticizer

The toner particles may contain a crystalline plasticizer for improving sharp melt properties. The plasticizer is not particularly limited, and known plasticizers used in toners as described below can be used.

Specific examples of the plasticizer include esters of monohydric alcohol and aliphatic carboxylic acid, such as behenyl behenate, stearyl stearate, and palmityl palmitate, or esters of carboxylic acid and aliphatic alcohol; esters of dihydric alcohol and aliphatic carboxylic acid, such as ethylene glycol distearate, dibehenyl sebacate, and hexanediol dibehenate, or esters of carboxylic acid and aliphatic alcohol; esters of trihydric alcohol and aliphatic carboxylic acid, such as glycerin tribehenate, or esters of trihydric carboxylic acid and aliphatic alcohol; esters of tetrahydric alcohol and aliphatic carboxylic acid, such as pentaerythritol tetrastearate and pentaerythritol tetrapalmitate, or esters of tetrahydric carboxylic acid and aliphatic alcohol; esters of hexahydric alcohol and aliphatic carboxylic acid, such as dipentaerythritol hexastearate and dipentaerythritol palmitate, or esters of hexahydric carboxylic acid and aliphatic alcohol; esters of polyhydric alcohol and aliphatic carboxylic acid, such as polyglycerin behenate, or esters of polyhydric carboxylic acid and aliphatic alcohol; and natural ester waxes such as carnauba wax and rice wax. These may be used alone or in combination.

### Crystalline Polyester

The toner particles can contain crystalline polyester. The crystalline polyester can be a condensation polymer of a monomer containing an aliphatic diol and/or an aliphatic dicarboxylic acid. Further, the crystalline polyester denotes polyester having a clear melting point as measured using a differential scanning calorimeter (DSC).

The crystalline polyester may have a monomer unit derived from an aliphatic diol having 2 or more and 12 or less carbon atoms (more preferably 6 or more and 12 or less carbon atoms) and/or a monomer unit derived from an aliphatic dicarboxylic acid having 2 or more and 12 or less carbon atoms (more preferably 6 or more and 12 or less carbon atoms).

The crystalline polyester having such a structure can be used from the viewpoint that the dispersibility of the crystalline polyester between the toner particles is enhanced so that unevenness of wet spreadability between the toner particles during fixation can be suppressed, and thus the low-temperature fixability of a halftone image or a line image is enhanced.

Examples of the aliphatic diol having 2 or more and 12 or less carbon atoms include compounds such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, and 1,12-dodecanediol.

Further, an aliphatic diol having a double bond can also be used. Examples of the aliphatic diol having a double bond include compounds such as 2-butene-1,4-diol, 3-hexene-1,6-diol, and 4-octene-1,8-diol.

Examples of the aliphatic dicarboxylic acid having 2 or more and 12 or less carbon atoms include compounds such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, and 1,12-dodecanedicarboxylic acid. Lower alkyl esters or acid anhydrides of these aliphatic dicarboxylic acids can also be used. Among these, sebacic acid, adipic acid, 1,10-decanedicarboxylic acid, and lower alkyl esters and acid anhydrides thereof are suitable. These can be used alone or in the form of a mixture of two or more kinds thereof.

Further, an aromatic dicarboxylic acid can also be used. Examples of the aromatic dicarboxylic acid include compounds such as terephthalic acid, isophthalic acid, 2,6-naphthalenedicarboxylic acid, and 4,4′-biphenyldicarboxylic acid. Among these, terephthalic acid is suitable from the viewpoints of availability and ease of forming a polymer having a low melting point.

Further, a dicarboxylic acid having a double bond can also be used. The dicarboxylic acid having a double bond suppresses hot offset during fixation and thus can be suitably used in terms that the entire resin can be crosslinked by using the double bond thereof. Examples of such a dicarboxylic acid include fumaric acid, maleic acid, 3-hexenedioic acid, 3-octenedioic acid, and lower alkyl esters and acid anhydrides thereof. Among these, fumaric acid and maleic acid are more suitable.

A method of producing the crystalline polyester is not particularly limited, and the crystalline polyester can be produced by a typical polyester polymerization method of reacting a dicarboxylic acid component with a diol component. The crystalline polyester can be produced, for example, by using an appropriate method such as a direct polycondensation method or a transesterification method depending on the kind of monomer.

The peak temperature of the maximum endothermic peak of the crystalline polyester as measured using a differential scanning calorimeter (DSC) is preferably 50.0° C. or higher and 100.0° C. or lower and more preferably 60.0° C. or higher and 90.0° C. or lower from the viewpoint of low-temperature fixability.

From the viewpoint of the balance between the low-temperature fixability and the durability, the content of the crystalline polyester in the toner is preferably 3.0% by mass or greater and 15.0% by mass or less.

### Colorant

The toner particles may contain a colorant. A known pigment or a known dye can be used as the colorant. From the viewpoint of excellent weather resistance, a pigment is suitable as the colorant.

Examples of a cyan-based colorant include a copper phthalocyanine compound and a derivative thereof, an anthraquinone compound, and a base dye lake compound. Specific examples thereof include C.I. Pigment Blue 1, 7, 15, 15:1, 15:2, 15:3, 15:4, 60, 62, and 66.

Examples of a magenta-based colorant include a condensed azo compound, a diketopyrrolopyrrole compound, an anthraquinone compound, a quinacridone compound, a base dye lake compound, a naphthol compound, a benzimidazolone compound, a thioindigo compound, and a perylene compound. Specific examples thereof include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of a yellow-based colorant include a condensed azo compound, an isoindolinone compound, an anthraquinone compound, an azo metal complex, a methine compound, and an allylamide compound. Specific examples thereof include C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194. Examples of a black colorant include colorants toned to black using the yellow-based colorant, the magenta-based colorants, and the cyan-based colorants described above, carbon black, and a magnetic material.

These colorants can be used alone or in the form of a mixture, and can also be used as a solid solution. The content of the colorant is preferably 1.0 parts by mass or greater and 20.0 parts by mass or less with respect to 100.00 parts by mass of the binder resin. Further, in a case where a production method carried out in an aqueous medium described below using a magnetic material is employed, a hydrophobic treatment can also be performed for the purpose of allowing the resin to stably contain a magnetic material.

### Charge Control Agent and Charge Control Resin

The toner particles may contain a charge control agent or a charge control resin. As the charge control agent, a known charge control agent can be used, and particularly a charge control agent that has a high triboelectric charging speed and is capable of stably maintaining a constant triboelectric charging amount is suitable. Further, in a case where the toner particles are produced by a suspension polymerization method, a charge control agent that has low polymerization inhibition properties and is substantially free from a solubilized substance in an aqueous medium is particularly suitable.

Examples of a charge control agent that controls the toner to be negatively charged include a monoazo metal compound, an acetylacetone metal compound, an aromatic oxycarboxylic acid-based metal compound, an aromatic dicarboxylic acid-based metal compound, an oxycarboxylic acid-based metal compound, a dicarboxylic acid-based metal compound, an aromatic oxycarboxylic acid, an aromatic monocarboxylic acid, an aromatic polycarboxylic acid, and metal salts thereof, anhydrides, esters, phenol derivatives such as bisphenol, urea derivatives, a metal-containing salicylic acid-based compound, a metal-containing naphthoic acid-based compound, a boron compound, a quaternary ammonium salt, a calixarene, an a charge control resin.

Examples of the charge control resin include a polymer or copolymer containing a sulfonic acid group, a sulfonate group, or a sulfonic acid ester group. The polymer containing a sulfonic acid group, a sulfonate group, or a sulfonic acid ester group is particularly suitably a polymer containing 2% by mass or greater of a sulfonic acid group-containing acrylamide-based monomer or a sulfonic acid group-containing methacrylamide-based monomer and more suitably a polymer containing 5% by mass or greater thereof in terms of the copolymerization ratio.

The charge control resin have a glass transition temperature (Tg) of preferably 35° C. or higher and 90° C. or lower, a peak molecular weight (Mp) of preferably 10,000 or greater and 30,000 or less, and a weight-average molecular weight (Mw) of preferably 25,000 or greater and 50,000 or less. In a case where such a charge control resin is used, suitable triboelectric charge characteristics can be imparted to the toner particles without affecting thermal characteristics required for the toner particles. Further, in a case where the charge control resin contains a sulfonic acid group, for example, the dispersibility of the charge control resin and the dispersibility of a colorant and the like in a polymerizable monomer composition are improved, and the coloring power, the transparency, and the triboelectric charge characteristics can be improved.

These charge control agents or charge control resins may be respectively used alone or in combination of two or more kinds thereof for addition. The amount of the charge control agent or charge control resin to be added is preferably 0.01 parts by mass or greater and 20.0 parts by mass or less and more preferably 0.5 parts by mass or greater and 10.0 parts by mass or less with respect to 100.0 parts by mass of the binder resin.

### Suitable Aspects of Organic-Inorganic Composite Fine Particles

The organic-inorganic composite fine particles of the present disclosure can be produced, for example, according to the description of examples in WO2013/063291.

As the inorganic fine particles used in the organic-inorganic composite fine particles, alumina fine particles, titania fine particles, zinc oxide fine particles, strontium titanate fine particles, cerium oxide fine particles, calcium carbonate fine particles, and the like can be used in addition to the silica fine particles. Any combination of two or more kinds of particles selected from the group of the above-described fine particles can also be used, but the organic-inorganic composite fine particles of the present disclosure are required to contain silica fine particles. When the organic-inorganic composite fine particles contain silica fine particles, the negativity is increased, the electrostatic adhesive force between the polyester A and the resin particles is unlikely to be inhibited, and thus silica fine particles can be suitably used.

Known resin particles of the related art can be used as the resin particles contained in the organic-inorganic composite fine particles, but a vinyl-based resin can be suitably used from the viewpoints of the durability and the charging uniformity of the toner.

When the resin particles of the organic-inorganic composite fine particles contain an ester group, a microscopic positive region can be formed by deviation of the electric charge, and the electrostatic adhesive force between the organic-inorganic composite fine particles and the surface of the toner particles can be exhibited due to an interaction between the polyester A and the isophthalic acid unit described above.

A vinyl-based monomer having an ester structure can be suitably used to allow the resin particles to contain an ester group.

The adhesive strength between the resin particles of the organic-inorganic composite fine particles and the silica fine particles can be increased and the mechanical strength can also be increased by reacting the resin particles of the organic-inorganic composite fine particles with a part of a hydroxyl group of the silica fine particles. Therefore, a monomer represented by Formula [R3₃₋ₓ(OR¹)ₓ]SiR²Q can be used as the monomer forming the resin particles. x represents 1, 2, or 3, R¹ represents a methyl group or an ethyl group, R² represents an alkyl linking group represented by General Formula CₙH₂ₙ, n represents 1 or greater and 10 or less, R3 represents a methyl group or an ethyl group, and Q represents a substituted or unsubstituted vinyl group, an acrylate ester group, or a methacrylate ester group. Here, n represents 2 or greater and 10 or less in a case where Q represents a substituted or unsubstituted vinyl group.

Examples of the monomer include (3-acryloxypropyl) trimethoxysilane, (3-acryloxypropyl)triethoxysilane, methacryloxypropyltrimethoxysilane, methacryloxypropyltriethoxysilane, methacryloxymethyltrimethoxysilane, methacryloxymethyltriethoxysilane, (3-acryloxypropyl)methyldimethoxysilane, methacryloxypropylmethyldimethoxysilane, methacryloxypropyldimethylethoxysilane, 3-butenyltrimethoxysilane, 3-butenyltriethoxysilane, 4-pentenyltriethoxysilane, 4-pentenyltrimethoxysilane, 5-hexenetrimethoxysilane, 5-hexenemethyldimethoxysilane, and methacryloxypropyldimethylmethoxysilane.

Further, a combination of a styrene monomer and a monomer containing a (meth)acrylate ester group can also be used as the monomer forming the resin particles in order to adjust the abundance of the ester group contained in the resin particles and the C═O group derived from the ester group.

Further, the surface of the organic-inorganic composite fine particles can be hydrophobized by a surface treatment in order to enhance the chargeability in a high-temperature and high-humidity environment. Examples of the surface treatment include a silane coupling treatment, an oil treatment, and a surface treatment of forming an alumina cover layer, and the surface treatment can be appropriately selected from these methods. Further, a plurality of surface treatments can also be selected, and the order of selected treatments is optional.

Examples of the silane coupling agent used in the silane coupling treatment include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilylmercaptan, trimethylsilylmercaptan, triorganosilyl acrylate, vinyldimethylacetoxysilane, dimethylethoxysilane, dimethyldimethoxysilane, diphenyldiethoxysilane, 1-hexamethyldisiloxane, 1,3-divinyltetramethyldisiloxane, 1,3-diphenyltetramethyldisiloxane, and dimethylpolysiloxane having 2 to 12 siloxane units per molecule and containing a hydroxyl group bonded to Si per unit positioned at a terminal. These may be used alone or in combination of two or more kinds thereof. Suitable examples of the silane coupling agent include hexamethyldisilazane (HMDS).

Further, the surface may be subjected to a silicone oil treatment or may be treated by a combination of a silicone oil treatment and the hydrophobic treatment.

The number average particle diameter (D1) and the shape factor SF-2 of primary particles of the organic-inorganic composite fine particles can be appropriately controlled by changing the particle diameter of the inorganic fine particles to be used in the production of the organic-inorganic composite fine particles and the ratio between the amounts of the inorganic fine particles and the resin.

The ratio P2/P1 and the ratio P2/P3 of the organic-inorganic composite fine particles can be controlled by adjusting the kind of monomer forming the resin particles and the charging ratio between the monomer forming the resin particles and the silica fine particles.

### Method of Producing Toner

A method of producing the toner is not particularly limited, and the toner can be produced by using a known method such as a pulverization method, a suspension polymerization method, a dissolution suspension method, an emulsion aggregation method, or a dispersion polymerization method. Here, the toner particles can be produced by suitably using an emulsion aggregation method from the viewpoint of controlling the toner shape and easily uniformly dispersing the polyester A contained as the binder resin in the vicinity of the surface. Hereinafter, the emulsion aggregation method will be described in detail.

### Emulsion Aggregation Method

The emulsion aggregation method is a method of producing toner particles by preliminarily preparing an aqueous dispersion liquid of fine particles formed of a constituent material of toner particles which are relatively small with respect to the target particle diameter, aggregating the fine particles until the particle diameter of the particles reach a desired particle diameter of the toner particles in an aqueous medium, and fusing the resin by being heated or the like.

That is, according to the emulsion aggregation method, the toner particles are produced by performing “dispersion step” of preparing a fine particle dispersion liquid formed of a constituent material of toner particles, “aggregation step” of aggregating the fine particles formed of the constituent material of the toner particles and controlling the particle diameter until the particle diameter of the particles reaches the particle diameter of the toner particles, “fusion step” of performing melt adhesion on the resin contained in the obtained aggregated particles, “spheronization step” of heating the particles so that the particles are melted and controlling the surface shape of the toner particles, the subsequent “cooling step”, “annealing step” of heating and holding the toner particles at a temperature higher than or equal to the crystallization temperature of the binder resin or higher than or equal to the glass transition temperature of the binder resin, and “post-treatment step” of filtering and washing the toner particles with ion exchange water and removing the moisture of the washed toner particles to dry the toner particles. Next, each of these steps will be described.

### Step of Preparing Resin Fine Particle Dispersion Liquid (Dispersion Step)

The resin fine particle dispersion liquid can be prepared by a known method, but the present disclosure is not limited thereto. Examples of the known method include an emulsion polymerization method, a self-emulsification method, a phase inversion emulsification method of adding an aqueous medium to a resin solution dissolved in an organic solvent to emulsify the resin, and a forced emulsification method of performing a high-temperature treatment in an aqueous medium to forcibly emulsify the resin without using an organic solvent.

Specifically, the binder resin containing the polyester A is dissolved in an organic solvent that can dissolve the resin, and a surfactant and a basic compound are added thereto. In this case, when the binder resin is a crystalline resin having a melting point, the resin may be dissolved by being heated at the melting point or higher. Next, an aqueous medium is slowly added to the mixture while the mixture is stirred with a homogenizer or the like, to precipitate the resin fine particles. Thereafter, the solvent is removed by heating the mixture or reducing the pressure, thereby preparing an aqueous dispersion liquid of the resin fine particles. Any organic solvent can be used as the organic solvent used for dissolving the resin as long as the organic solvent can dissolve the resin, but it is desirable to use an organic solvent that forms a homogeneous phase with water, such as toluene, from the viewpoint of suppressing generation of coarse powder.

The surfactant used for the emulsification is not particularly limited, and examples thereof include an anionic surfactant such as a sulfuric acid ester salt-based surfactant, a sulfonate-based surfactant, a carbonate-based surfactant, a phosphoric acid ester-based surfactant, or a soap-based surfactant; a cationic surfactant such as an amine salt type surfactant or a quaternary ammonium salt type surfactant; and a nonionic surfactant such as a polyethylene glycol-based surfactant, an alkylphenol ethylene oxide adduct-based surfactant, or a polyhydric alcohol-based surfactant. The surfactant may be used alone or in combination of two or more kinds thereof.

Examples of the basic compound used in the dispersion step include an inorganic base such as sodium hydroxide or potassium hydroxide; and an organic base such as ammonia, triethylamine, trimethylamine, dimethylaminoethanol, or diethylaminoethanol. The basic compound may be used alone or in combination of two or more kinds thereof.

Further, the 50% particle diameter (D50) of fine particles of the binder resin based on volume distribution in the aqueous dispersion liquid of resin fine particles is preferably 0.05 μm or greater and 1.0 μm or less and more preferably 0.05 μm or greater and 0.4 μm or less. Toner particles having an appropriate volume average particle diameter of 3 μm or greater and 10 μm or less are easily obtained by adjusting the 50% particle diameter (D50) thereof based on volume distribution to be in the above-described ranges.

In addition, the 50% particle diameter (D50) of particles based on volume distribution is measured using a dynamic light scattering particle size distribution meter NANOTRAC UPA-EX150 (manufactured by Nikkiso Co., Ltd.).

### Colorant Fine Particle Dispersion Liquid

A colorant fine particle distribution liquid may be used as necessary. The colorant fine particle distribution liquid can be prepared by a known method described below, but the present disclosure is not limited thereto. The colorant fine particle distribution liquid can be prepared by mixing a colorant, an aqueous medium, and a dispersant using a known mixer such as a stirrer, an emulsifier, or a disperser. A known dispersant such as a surfactant or a polymer dispersant can be used as the dispersant used here.

Both dispersants, the surfactant and the polymer dispersant, can be removed in a washing step described below, but the surfactant is suitable from the viewpoint of washing efficiency.

Examples of the surfactant include an anionic surfactant such as a sulfuric acid ester salt-based surfactant, a sulfonate-based surfactant, a phosphoric acid ester-based surfactant, or a soap-based surfactant; a cationic surfactant such as an amine salt type surfactant or a quaternary ammonium salt type surfactant; and a nonionic surfactant such as a polyethylene glycol-based surfactant, an alkylphenol ethylene oxide adduct-based surfactant, or a polyhydric alcohol-based surfactant. Among these, a nonionic surfactant or an anionic surfactant is suitable. Further, a nonionic surfactant and an anionic surfactant may be used in combination. The surfactant may be used alone or in combination of two or more kinds thereof. The concentration of the surfactant in an aqueous medium is preferably 0.5% by mass or greater and 5% by mass or less.

The content of the colorant fine particles in the colorant fine particle dispersion liquid is not particularly limited, but is preferably 1% by mass or greater and 30% by mass or less with respect to the total mass of the colorant fine particle dispersion liquid.

In the dispersed particle diameter of the colorant fine particle in the aqueous dispersion liquid of the colorant, the 50% particle diameter (D50) based on the volume distribution is preferably 0.5 μm or less from the viewpoint of the dispersibility of the colorant in the toner to be finally obtained. Further, a 90% particle diameter (D90) based on the volume distribution is preferably 2 μm or less for the same reason. In addition, the dispersed particle diameter of the colorant fine particles dispersed in the aqueous medium is measured using a dynamic light scattering particle size distribution meter (NANOTRAC UPA-EX150, manufactured by Nikkiso Co., Ltd.).

Examples of the mixer such as a known stirrer, emulsifier, or disperser used when the colorant is dispersed in the aqueous medium include an ultrasonic homogenizer, a jet mill, a pressure homogenizer, a colloid mill, a ball mill, a sand mill, and a paint shaker. These may be used alone or in combination.

### Release Agent (Aliphatic Hydrocarbon Compound) Fine Particle Dispersion Liquid

A release agent fine particle dispersion liquid may be used as necessary. The release agent fine particle dispersion liquid can be prepared by a known method described below, but the present disclosure is not limited thereto.

The release agent fine particle dispersion liquid can be prepared by adding a release agent to an aqueous medium containing a surfactant, heating the mixture at a temperature higher than or equal to the melting point of the release agent, dispersing the release agent in the form of particles using a homogenizer (for example, “CLEARMIX W-MOTION”, manufactured by M Technique Co., Ltd.) having a strong shearing ability or a pressure ejection type disperser (for example, “GAULIN HOMOGENIZER”, manufactured by Gaulin Corporation), and cooling the mixture at a temperature lower than the melting point of the release agent.

In the dispersed particle diameter of the release agent fine particle dispersion liquid in the aqueous dispersion liquid of the release agent, the 50% particle diameter (D50) based on the volume distribution is preferably 0.03 μm or greater and 1.0 μm or less and more preferably 0.1 μm or greater and 0.5 μm or less. Further, desirably no coarse particles having a particle diameter of 1 μm or greater are present.

In a case where the dispersed particle diameter of the release agent fine particle dispersion liquid is in the above-described ranges, the release agent can be present in a state of being finely dispersed in the toner, a bleeding effect during fixation can be maximized, and satisfactory separation properties can be obtained. Further, the dispersed particle diameter of the release agent fine particle dispersion liquid dispersed in the aqueous medium can be measured using a dynamic light scattering particle size distribution meter NANOTRAC UPA-EX150 (manufactured by Nikkiso Co., Ltd.).

### Mixing Step

In the mixing step, a mixed solution is prepared by mixing the resin fine particle dispersion liquid with at least one of the release agent fine particle dispersion liquid and the colorant fine particle dispersion liquid as necessary. The mixed solution can be prepared by using a known mixing device such as a homogenizer or a mixer.

### Step of Forming Aggregate Particles (Aggregation Step)

In the aggregation step, the fine particles contained in the mixed solution prepared in the mixing step are aggregated to form aggregates with a target particle diameter. Here, an aggregating agent is added thereto and mixed into the mixture, and the mixture is appropriately subjected to heating and mechanical power as necessary to form aggregates in which the resin fine particles and at least one of the release agent fine particles and the colorant fine particles are aggregated.

Examples of the aggregating agent include an organic aggregating agent such as a quaternary salt cationic surfactant or polyethyleneimine; an inorganic metal salt such as sodium sulfate, sodium nitrate, sodium chloride, calcium chloride, or calcium nitrate; an inorganic ammonium salt such as ammonium sulfate, ammonium chloride, or ammonium nitrate; and an inorganic aggregating agent such as a di- or higher valent metal complex. Further, an acid can also be added to the mixed solution so that the pH is decreased and the particles are softly aggregated, and sulfuric acid, nitric acid, or the like can be used as the acid.

The aggregating agent may be added to the mixed solution in any form of dry powder or an aqueous solution dissolved in an aqueous medium, but the aggregating agent can be added in the form of an aqueous solution in order to uniformly aggregate the particles. Further, the aggregating agent can be added to and mixed into the mixed solution at a temperature lower than or equal to the glass transition temperature or the melting point of the resin contained in the mixed solution. When the aggregating agent is mixed into the mixed solution under the above-described temperature conditions, relatively uniform aggregation proceeds. The aggregating agent can be mixed into the mixed solution using a known mixing device such as a homogenizer or a mixer. The aggregation step is a step of forming aggregates having a toner particle size in the aqueous medium. The volume average particle diameter of the aggregates produced in the aggregation step is preferably 3 μm or greater and 10 μm or less. The volume average particle diameter can be measured by a coulter method using a particle size distribution analyzer (COULTER Multisizer III: manufactured by Beckman Coulter, Inc.).

### Step of Obtaining Dispersion Liquid Containing Toner Particles (Fusion Step)

In the fusion step, first, the aggregation is stopped while the dispersion liquid containing the aggregates obtained in the aggregation step is stirred in the same manner as in the aggregation step. The aggregation is stopped by adding an aggregation stopping agent such as a base, a chelate compound, or an inorganic salt compound such as sodium chloride, which can adjust the pH.

The dispersed state of the aggregated particles in the dispersion liquid is stabilized by the action of the aggregation stopping agent, the mixed solution is heated at a temperature higher than or equal to the glass transition temperature or the melting point of the binder resin to fuse the aggregated particles, and thus the particles having a desired particle diameter are prepared.

Further, the 50% particle diameter (D50) based on volume distribution of the toner particles is preferably 3 μm or greater and 10 μm or less.

### Step of Obtaining Desired Surface Shape of Toner (Spheronization Step)

The spheronization step of further increasing the temperature and maintaining the temperature until the toner particles have a desired circularity or surface shape can be performed during or after the fusion step. The specific temperature of the spheronization step is, for example, preferably 90° C. or higher and more preferably 92° C. or higher, and preferably 95° C. or lower. The heating time in the spheronization step is, for example, 3 hours or longer, 5 hours or longer, or 8 hours or longer. In the present step, a hydrogen bond derived from boric acid is likely to be formed in the toner particles.

### Cooling Step

The cooling step of decreasing the temperature of the dispersion liquid containing the obtained toner particles to a temperature lower than the crystallization temperature or the glass transition temperature of the binder resin can be performed by controlling the cooling rate after the spheronization step. Since formation of unevenness on the surface of the toner particles accompanied by a change in volume, such as expansion or contraction, of the material in the toner particles can be suppressed by performing the cooling step, the shape factor SF1 (cross section) is easily controlled to 105 or greater and 125 or less, and the ground area ratio (D/S) of the toner is easily controlled to 14% or less. Further, since the change in volume can be further suppressed by increasing the cooling rate, occurrence of recesses in the surface of the toner particles can be suppressed, a desired circularity or a desired surface shape obtained in the spheronization step can be maintained, the shape factor SF1 of the toner and the shape factor SF1 (cross section) thereof can be set to 125 or less, and the ground area ratio (D/S) of the toner can be set to 14% or less. Specifically, the cooling rate is 0.1° C./see or greater, preferably 0.5° C./see or greater, more preferably 2° C./see or greater, and still more preferably 4° C./see or greater.

### Annealing Step

An annealing step of heating the mixed solution at a temperature higher than or equal to the crystallization temperature or higher than or equal to the glass transition temperature of the binder resin or at a temperature lower than or equal to the crystallization temperature of a release agent in a case where the mixed solution contains a release agent and maintaining the temperature can be performed after the cooling step. Since the change in volume can be further suppressed by performing the annealing step, generation of recesses in the surface of the toner particles can be suppressed. Therefore, a desired circularity or a desired surface shape obtained by performing the cooling step can be maintained, the shape factor SF1 of the toner and the shape factor SF1 (cross section) thereof can be set to 125 or less, and the ground area ratio (D/S) of the toner can be set to 14% or less. Specifically, the annealing temperature is 45° C. or higher and 75° C. or lower, preferably 50° C. or higher and 70° C. or lower, and more preferably 55° C. or higher and 65° C. or lower. The heat treatment time of the annealing step is, for example, within 5 hours and preferably in a range of 2 to 3 hours.

### Post-Treatment Step

In the method of producing the toner, post-treatment steps such as a washing step, a solid-liquid separation step, a drying step, and the like may be performed, and toner particles in a dried state can be obtained by performing the post-treatment steps.

### External Addition Step of Organic-Inorganic Composite Fine Particles

The organic-inorganic composite fine particles are externally added to the toner particles obtained as described above. Other known fine particles of the related art may be used in combination as necessary.

The amount of the organic-inorganic composite fine particles may be 0.1 parts by mass or greater and 5.0 parts by mass or less and is preferably 0.1 parts by mass or greater and 3.0 parts by mass or less and more preferably 0.2 parts by mass or greater and 2.0 parts by mass or less with respect to 100 parts by mass of the toner particles from the viewpoint of achieving both the durability of the toner and the anti-contamination properties of the charging member.

### Method of Measuring Each Physical Property

Next, a method of measuring each physical property according to the present disclosure will be described.

### Method of Isolating Toner Particles and Organic-Inorganic Composite Fine Particles and Method of Measuring Content of Organic-Inorganic Composite Fine Particles in Toner

0.50 g of Triton-X100 (manufactured by Kishida Chemical Co., Ltd.) is added to 100 g of ion exchange water to prepare a dispersion medium.
(1) 1.00 g of the toner is precisely weighed in a vial, the above-described dispersion medium is added thereto such that the total amount of the mixture reaches 10.00 g, and the mixture is allowed to stand for 24 hours to prepare a sample liquid.
(2) The sample liquid is subjected to an ultrasonic homogenizer treatment to release the external additive from the toner, and the external additive is dispersed in a dispersion medium.
Ultrasonic treatment device: ultrasonic homogenizer VP-050 (manufactured by TAITEC CORPORATION)
Microchip: step type microchip, tip diameter: $2 mm
Tip position of microchip: central portion of glass vial at height of 5 mm from bottom surface of vial
Conditions for ultrasonic waves: intensity of 30% for 180 minutes, here, ultrasonic waves are applied while the vial is cooled with ice water so that the dispersion liquid is not heated
(3) The toner particles in the sample liquid are separated from the dispersion medium in which the external additive is dispersed by suction filtration (10 μm membrane filter) (filtrate).
(4) The filtered toner particles are recovered, the dispersion medium is added thereto again so that the total amount of the mixture reaches 10.00 g, the above-described processes (2) and (3) are repeated ten times, and the entire filtrate is recovered.
(5) In a case where other external additives have been externally added, the recovered filtrate is centrifuged using a centrifuge to separate the other external additives so that the organic-inorganic composite fine particles are recovered.
(6) The recovered organic-inorganic composite fine particles are sufficiently dried at 60° C. for 24 hours using a vacuum dryer to isolate the dried organic-inorganic composite fine particles.

The mass of the organic-inorganic composite fine particles contained in 1.00 g of the toner is determined by measuring the mass of the dried organic-inorganic composite fine particles. Further, a value obtained by multiplying the obtained mass by 100 is defined as the content (% by mass) of the organic-inorganic composite fine particles in the toner.

### Method of Determining Whether Resin Particles of Organic-Inorganic Composite Fine Particles Contain Ester Group

Identification using pyrolysis-GCMS

Specific conditions for measurement using pyrolysis-GCMS are described below.
Mass spectrometer: ISQ (manufactured by Thermo Fisher Scientific Inc.)
GC device: Focus GC (manufactured by Thermo Fisher Scientific Inc.)
Ion source temperature: 250° C.
Ionization method: EI
Mass range: 50 to 1,000 m/z
Column: HP-5 MS [30 m]
Pyrolyzer: JPS-700 (manufactured by Japan Analytical Industry Co., Ltd.)

A small amount of the organic-inorganic composite fine particles and 1 μL of tetramethylammonium hydroxide (TMAH) are added to pyrofoil at 590° C. The prepared sample undergoes pyrolysis-GCMS measurement under the above-described conditions, thereby obtaining peaks derived from the organic-inorganic composite fine particles. Due to the action of TMAH, which is a methylating agent, compounds constituting the resin component are detected as methylated materials. In a case where the obtained peaks are analyzed and the compounds constituting the resin component include a compound containing an ester group, it is determined that the resin particles of the organic-inorganic composite fine particles contain an ester group.

### Method of Measuring Number Average Particle Diameter (D1) of Organic-Inorganic Composite Fine Particles

The number average particle diameter (D1) of the primary particles of the organic-inorganic composite fine particles is measured by using a scanning electron microscope “S-4800” (trade name, manufactured by Hitachi, Ltd.).

The number average particle diameter (D1) is determined by observing the toner to which the organic-inorganic composite fine particles are externally added and measuring the major axes of the primary particles of 100 organic-inorganic composite fine particles, which have been randomly selected, in a visual field magnified up to 200,000 times. The observation magnification is appropriately adjusted depending on the size of the organic-inorganic composite fine particles.

### Method of Measuring SF-2 of Organic-Inorganic Composite Fine Particles

The shape factor SF-2 of the organic-inorganic composite fine particles is measured by using a scanning electron microscope “S-4800” (trade name: Hitachi, Ltd.).

The measurement is performed by observing the toner to which the organic-inorganic composite fine particles have been externally added, and the calculation is carried out as described below.

The observation magnification is appropriately adjusted depending on the size of the organic-inorganic composite fine particles. The perimeters and the areas of the primary particles of 100 organic-inorganic composite fine particles, which have been randomly selected, are calculated by using image process software “Image-Pro Plus 5.1J” (manufactured by Media Cybernetics) in a visual field magnified up to 200,000 times.

The shape factor SF-2 is calculated according to the following equation, and the average value thereof is defined as SF-2.

$$SF - 2 = {( perimeter of particle )}^{2} / area of particle \times 100 / 4 π$$

### Method of Measuring Content of Silica Fine Particles in Organic-Inorganic Composite Fine Particles

The content of the silica fine particles in the organic-inorganic composite fine particles is measured by using TGA Q5000IR (manufactured by TA Instruments). The measurement is performed by the following procedures.

10.0 mg of the sample is weighed in a sample pan and set to a main body.

Further, the sample is maintained at a temperature of 50° C. for 1 minute in an oxygen gas atmosphere, heated to 900° C. at a temperature increasing rate of 25° C./min, and a change in weight of the sample at this time is measured. In addition, the content of the inorganic fine particles in organic-inorganic composite fine particles B is determined according to the following equation based on a mass (W1) of the initial sample and a mass (W2) of the sample at the time point when the sample is heated to 900° C.

$$Content ( \% by mass ) of silica fine particles = W 2 / W 1 \times 100$$

When the externally added organic-inorganic composite fine particles are available, these particles are used as the sample. In a case where the particles are not available, the organic-inorganic composite fine particles are isolated from the toner and can be measured.

### Method of Measuring Ratios P2/P1 and P2/P3 of Organic-Inorganic Composite Fine Particles Method of Measuring P1, P2, and P3 by ATR-IR

The FT-IR spectrum is measured by the ATR method using a Fourier transform infrared spectrometer (Spectrum One, manufactured by PerkinElmer Inc.) equipped with a universal ATR measurement accessory (Universal ATR Sampling Accessory). The specific measurement procedures and the method of calculating P1 and P2 are as follows.

A Ge ATR crystal (refractive index of 4.0) is used as the ATR crystal.

Other conditions are as follows.

### Range

Start: 4,000 cm⁻¹
End: 600 cm⁻¹ (Ge ATR crystal)
Scan number: 8
Resolution: 4.00 cm⁻¹
Advanced: with CO₂/H₂O correction

The device is equipped with a Ge ATR crystal (refractive index of 4.0) and set in an absorbance measurement mode, the background is firstly measured, 0.01 g of the organic-inorganic composite fine particles are precisely weighed on the ATR crystal, the sample is pressurized (Force Gauge is adjusted to be in a range of 70 to 80) with a pressure arm, and the FT-IR spectrum of the organic-inorganic composite fine particles is measured.

The peak heights of P1, P2, and P3 are determined by analyzing the obtained FT-IR spectrum.

### Method of Calculating Peak Height of P1

P1 is a peak derived from Si—O contained in the silica fine particles of the organic-inorganic composite fine particles and has a peak top at 1,100 cm⁻¹ or greater and 1,120 cm⁻¹ or less. In the obtained FT-IR spectrum, a baseline is drawn by connecting minimum values of the spectrum in a range of 884 cm⁻¹ or greater and 1,347 cm⁻¹ or less, and the peak height of P1 with respect to the baseline is determined.

### Method of Calculating Peak Height of P2

P2 is a peak derived from C═O contained in the resin particles of the organic-inorganic composite fine particles and has a peak top at 1,715 cm⁻¹ or greater and 1,735 cm⁻¹ or less.

In the obtained FT-IR spectrum, a baseline is drawn by connecting minimum values of the spectrum in a range of 1,660 cm⁻¹ or greater and 1,805 cm⁻¹ or less, and the peak height of P2 with respect to the baseline is determined.

### Method of Calculating Peak Height of P3

P3 is a peak derived from out-of-plane bending vibration of a benzene ring of styrene contained in the resin particles of the organic-inorganic composite fine particles and has a peak top at 680 cm⁻¹ or greater and 710 cm⁻¹ or less.

In the obtained FT-IR spectrum, a baseline is drawn by connecting minimum values of the spectrum in a range of 650 cm⁻¹ or greater and 730 cm⁻¹ or less, and the peak height of P3 with respect to the baseline is determined.

### Method of Calculating Ratio P2/P1

The ratio P2/P1 is calculated by dividing the peak height of P2 by the peak height of P1.

### Method of Calculating Ratio P2/P3

The ratio P2/P3 is calculated by dividing the peak height of P2 by the peak height of P3.

### Method of Measuring Surface Exposure Rate B of Silica of Organic-Inorganic Composite Fine Particles

In a case where the inorganic fine particles present on the surface of the organic-inorganic composite fine particles are silica fine particles, a surface exposure rate B of silica can be measured by the following method.

The surface exposure rate B of silica of the organic-inorganic composite fine particles is measured by ESCA (X-ray photoelectron spectroscopic analysis).

The surface exposure rate B thereof is calculated from the amount of silicon atoms (hereinafter, abbreviated as Si) derived from silica. ESCA is an analytical method of detecting atoms in a region of several nanometers or less in a depth direction of the sample surface. Therefore, the atoms on the surface of the organic-inorganic composite fine particles can be detected.

A platen (provided with a screw hole having a diameter of about 1 mm for fixing the sample) with a size of 75 mm square, which is attached to the device, is used as a sample holder. Since the screw hole penetrates through the platen, the hole is closed with a resin or the like to prepare a recess for measuring powder with a depth of about 0.5 mm. The recess is packed with the measurement sample with a spatula or the like, and the material is leveled off to prepare a sample.

A device of ESCA and measurement conditions are as follows.
Device to be used: Quantum 2000 (manufactured by ULVA-PHI, INCORPORATED)
Analytical method: narrow analysis
Measurement conditions:
X-ray source: Al-Kα
X-ray conditions: 100 μm, 25 W, 15 kV
Photoelectron capturing angle: 45°
Pass energy: 58.70 eV
Measurement range: ϕ100 μm

The measurement is performed under the above-described conditions.

First, the organic-inorganic composite fine particles are measured to calculate the quantitative value of Si atoms using the peaks of C1c (B.E. 280 to 295 eV), O1s (B.E. 525 to 540 eV), and Si2p (B.E. 95 to 113 eV). The quantitative value of Si atoms obtained here is defined as X1.

Next, elemental analysis is performed on the single substance of silica fine particles in the same manner as described above, and the quantitative value of Si elements obtained here is defined as X2.

In the present disclosure, the surface exposure rate B of silica is determined according to the following equation using the values X1 and X2.

$$Surface exposure rate B ( \% ) of silica = X 1 / X 2 \times 100$$

Further, the calculation is performed using, as the single substance of silica fine particles, silica fine particles 4 (number average particle diameter of 110 nm) obtained by a sol-gel method described in the production example in the example below. The abundance ratio of silica on the surface is 100% in a case where the external additive is a single substance of silica, and the abundance ratio of silica on the surface of the resin particles is 0% in a case where the surface has not been subjected to a surface treatment.

### Method of Isolating Toner Particles

In the item (4) of the method of isolating the organic-inorganic composite fine particles and the method of measuring the content of the organic-inorganic composite fine particles in the toner, the toner particles obtained by repeatedly performing filtration a total of ten times are recovered and sufficiently dried at 45° C. for 24 hours, thereby isolating the toner particles.

Method of Isolating Binder Resin from Toner Particles

100 mg of the toner particles are dissolved in 3 ml of chloroform. Next, the solution is subjected to suction filtration with a syringe equipped with a sample treatment filter (pore size of 0.2 μm or greater and 0.5 μm or less, for example, using “MYSHORIDISC H-25-2” (manufactured by Tosoh Corporation) to remove insoluble matter. Soluble matter is introduced to a preparative HPLC (device: LC-9130 NEXT, manufactured by Japan Analytical Industry Co., Ltd., preparative column [60 cm], exclusion limit: 20,000 and 70,000, two columns are connected), and a chloroform eluent is sent. When a peak can be confirmed in the display of a chromatograph to be obtained, the retention time at which the molecular weight of a monodisperse polystyrene standard sample is 2,000 or greater is dispensed.

The solution of the obtained fraction is dried and solidified so that the binder resin is dispensed by being separated from the release agent.

### Composition Analysis of Binder Resin Formed of Plurality of Components

A chloroform soluble matter of the dispensed binder resin is used as a sample. The sample is prepared such that the concentration of the toner particles in chloroform reaches 0.1% by mass, and the solution is filtered through a PTFE filter having a pore size of 0.45 μm and used in the measurement. The conditions for gradient polymer LC measurement are as follows.
Device: ULTIMATE 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
(Further, the gradient in change of mobile phase is set to be linear.)
Flow rate: 1.0 mL/min
Injection: 0.1% by mass×20 μL
Column: Tosho TSKgel ODS (4.6 mmϕ×150 mm×5 μm)
Column temperature: 40° C.
Detector: Corona charged particle detector (Corona-CAD) (manufactured by Thermo Fisher Scientific Inc.)

The polyester A is dispensed at a time (7 minutes to 9 minutes) corresponding to the polyester A. Further, the crystalline polyester is dispensed at a time (13 minutes to 15 minutes) corresponding to the crystalline polyester.

In the dispensation, required amounts of chloroform/acetonitrile solutions are collected for each of the polyester A and the crystalline polyester, dried, concentrated, and used as samples of the polyester A (resin A) and the crystalline polyester (resin B).

The composition ratio and the mass ratio between the samples of the resin A component and the resin B component by nuclear magnetic resonance spectrometry (NMR) as described below.

1 mL of deuterated chloroform is added to 20 mg of the samples of the resin A component and the resin B component, and NMR spectrum of the protons in the dissolved resins is measured. The molar ratio and the mass ratio of each monomer are calculated from the obtained NMR spectrum, and the content proportion of each monomer unit can be determined.

For example, in a case of a styrene-acrylic copolymer, the composition ratio and the mass ratio can be calculated based on a peak at about 6.5 ppm derived from a styrene monomer and a peak derived from an acrylic monomer at about 3.5 ppm to 4.0 ppm.

The device and the measurement conditions described below can be used for nuclear magnetic resonance spectrometry (NMR).
NMR device: RESONANCE ECX 500 (manufactured by JEOL Ltd.)
Observed nucleus: proton
Measurement mode: single pulse
Quantitative method for Uᵢₛₒ, U_{EO}, and U_{PO} in polyester A by NMR measurement

Identification of the component of the polyester A and measurement of the molar ratio and the mass ratio by the nuclear resonance spectrometry (NMR) are performed as follows.

1 mL of deuterated chloroform is added to 20 mg of the obtained polyester A, and the NMR spectrum of protons of the dissolved polyester A is measured. The molar ratio and the mass ratio of each monomer are calculated from the obtained NMR spectrum by assuming that the minimum unit sandwiched between ester bonds is a structure derived from the monomer.

For example, the composition ratio and the mass ratio can be calculated based on the following peaks (chemical shift values, number of protons).
Unit derived from isophthalic acid: 7.5 ppm (1), 8.2 ppm (2), 8.7 ppm (1)
Unit derived from terephthalic acid: 8.1 ppm (4)
Unit derived from ethylene oxide adduct of bisphenol A: 1.6 ppm (6), 4.3 ppm (4), 4.7 ppm (4), 6.8 ppm (4), 7.1 ppm (4)
Unit derived from propylene oxide adduct of bisphenol A: 1.5 ppm (6), 1.6 ppm (6), 4.1 ppm (4), 5.5 ppm (2), 6.8 ppm (4), 7.1 ppm (4)
Unit derived from ethylene glycol: 4.3 ppm (4)
NMR device: JEOL RESONANCE ECX500
Observed nucleus: proton, measurement mode: simple pulse, Reference peak: TMS

The content (% by mole) of the unit Uᵢₛₒ derived from isophthalic acid with respect to the amount of all units derived from an acid component is determined by the NMR analysis. Further, the total content proportion (% by mole) of the units U_{EO} and U_{PO} with respect to the amount of all units derived from an alcohol component is determined. Further, the content proportion (% by mole) of U_{EO} with respect to the total content proportion of the units U_{EO} and U_{PO} is determined.

### Method of Measuring Weight-Average Molecular Weight Mw and Number Average Molecular Weight Mn

The molecular weights of samples such as the polyester A, the crystalline polyester, and styrene acryl are measured by gel permeation chromatography (GPC) as described below.

First, the samples are dissolved in tetrahydrofuran (THF). The polyester A and the styrene acryl are dissolved in THF at room temperature over 24 hours. Further, the crystalline polyester is dissolved in THE after THE is heated to 40° C., and the solution is allowed to stand for 24 hours.

Each solution in which each sample is dissolved is filtered through a solvent-resistant membrane filter “MYSHORIDISC” (manufactured by Tosoh Corporation) having a pore size of 0.2 μm to obtain a sample solution. Further, the sample solution is prepared such that the concentration of the component soluble in THF is adjusted to 0.8% by mass. The measurement is performed using this sample solution under the following conditions.
Device: HLC8120GPC (detector: RI) manufactured by Tosoh Corporation)
   Column: seven units of Shodex KF-801, 802, 803, 804, 805, 806, and 807 (manufactured by Showa Denko K.K.)
Eluent: tetrahydrofuran (THF)
Flow rate: 1.0 ml/min
Oven temperature: 40.0° C.
Sample injection volume: 0.10 ml

The molecular weight of each sample is calculated by using a molecular weight calibration curve prepared with a standard polystyrene resin (for example, trade name “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation).

### Method of Measuring Melting Point

The melting points of the crystalline polyester, the release agent, the plasticizer, and the like are measured using a differential scanning calorimeter (DSC) Q2000 (manufactured by TA Instruments).
Temperature increasing rate: 10° C./min
Measurement start temperature: 20° C.
Measurement end temperature: 180° C.

The melting points of indium and zinc are used for correcting the temperature of a device detection unit, and heat of fusion of indium is used for correcting the heat quantity. Specifically, about 5 mg of the sample is precisely weighed and placed in an aluminum pan, and the measurement is performed once. An empty aluminum pan is used as a reference. Here, the peak temperature of the maximum endothermic peak is defined as the melting point.

### Measurement of Glass Transition Temperature Tg

The glass transition temperature Tg is measured by using a differential scanning calorimeter “Q2000” (manufactured by TA Instruments) in conformity with ASTM D3418-82. The melting points of indium and zinc are used for correcting the temperature of a device detection unit, and heat of fusion of indium is used for correcting the heat quantity. Specifically, about 2 mg of the sample is precisely weighed and placed in an aluminum pan, an empty aluminum pan is used as a reference, and the measurement is performed in a measurement temperature range of −10° C. to 200° C. at a temperature increasing rate of 10° C./min. Further, in the measurement, the temperature is increased once to 200° C., decreased to −10° C., and then increased again. A change in specific heat is obtained in a temperature range of 30° C. to 100° C. in the second temperature increasing process. The intersection point of a line between midpoints of baselines before and after the change in specific heat occurs and a differential thermal curve is defined as the glass transition temperature Tg.

### Measurement of Acid Value

The acid value is the number of milligrams of potassium hydroxide required to neutralize the acid contained in 1 g of the sample.

The acid value in the present disclosure is measured in conformity with JIS K 0070-1992, and specifically, the acid value is measured by the following procedures.

Titration is performed using a 0.1 mol/l potassium hydroxide ethyl alcohol solution (manufactured by Kishida Chemical Co., Ltd.). The factor of the potassium hydroxide ethyl alcohol solution can be determined by using a potentiometric titration device (potentiometric titration measuring device At-510, manufactured by Kyoto Electronics Manufacturing Co., Ltd.). 100 ml of 0.100 mol/l hydrochloric acid is placed in a 250 ml tall beaker and titrated with the potassium hydroxide ethyl alcohol solution, and the acid value is determined from the amount of the potassium hydroxide ethyl alcohol solution required for neutralization. Hydrochloric acid prepared in conformity with JIS K 8001-1998 is used as the 0.100 mol/l hydrochloric acid.

The conditions for measuring the acid value are described below.
Titration device: potentiometric titration device AT-510 (manufactured by Kyoto Electronics Manufacturing Co., Ltd.)
Electrode: composite glass electrode double junction type (manufactured by Kyoto Electronics Manufacturing Co., Ltd.)
Software for controlling titration device: AT-WIN
Titration analysis software: Tview

The titration parameter and the control parameter during the titration are determined as follows.
Titration parameter
Titration mode: blank titration
Titration style: total amount titration
Maximum titer: 20 ml
Waiting time before titration: 30 seconds
Titration direction: automatic

### Control Parameter

End point determination potential: 30 dE
End point determination potential value: 50 dE/dmL
End point detection determination: not set
Control speed mode: standard
Gain: 1
Data collection potential: 4 mV
Data collection titer: 0.1 ml
Main test: 0.100 g of the measurement sample is precisely weighed in a 250 ml tall beaker, and 150 ml of a mixed solution of toluene and ethanol at a mixing ratio of 3:1 is added thereto to dissolve the sample over 1 hour. The titration is performed using the potassium hydroxide ethyl alcohol solution with the potentiometric titration device. Blank test: Titration is performed by carrying out the same operation as described above except that the sample is not used (that is, only the mixed solution of toluene and ethanol at a mixing ratio of 3:1 is used). The obtained results are substituted into the following equation to calculate the acid value.

$$A = [ ( C - B ) \times f \times 5.6 \; 11 ] / S$$

(In the equation, A represents the acid value (mgKOH/g), B represents the amount (ml) of the potassium hydroxide ethyl alcohol solution to be added in the black test, C represents the amount (ml) of the potassium hydroxide ethyl alcohol solution to be added in the main test, f represents the factor of the potassium hydroxide ethyl alcohol solution, and S represents the sample (g).)

### Method of Measuring Average Circularity of Toner (Particles)

The average circularity of the toner or the toner particles is measured using a flow type particle image analyzer “FPIA-3000” (manufactured by Sysmex Corporation) under measurement and analysis conditions during the calibration work.

An appropriate amount of alkylbenzene sulfonate serving as a surfactant is added to 20 mL of ion exchange water as a dispersant, 0.02 g of a measurement sample is added thereto, and a dispersion treatment is performed on the mixture for 2 minutes using a table top ultrasonic cleaner disperser (trade name: VS-150, manufactured by VELVO-CLEAR) at an oscillation frequency of 50 kHz and an electrical output of 150 watts to obtain a dispersion liquid for measurement. In this case, the dispersion liquid is appropriately cooled such that the temperature of the dispersion liquid is 10° C. or higher and 40° C. or lower.

The measurement is performed by using the flow type particle image analyzer equipped with a standard objective lens (10 times) and a particle sheath “PSE-900A” (manufactured by Sysmex Corporation) as a sheath liquid. The dispersion liquid prepared by the above-described procedures is introduced to the flow type particle image analyzer, 3,000 toner particles are measured in a total count mode and an HPF measurement mode, the binarization threshold value during particle analysis is set to 85%, the particle diameter for analysis is limited to an equivalent circle diameter of 1.98 μm or greater and 19.92 μm or less, thereby determining the average circularity of the toner particles.

In the measurement, automatic focus adjustment is performed using standard latex particles (for example, 5100A (trade name, manufactured by Duke Scientific Corporation) diluted with ion exchange water) before the start of measurement. Thereafter, focus adjustment can be performed every two hours from the start of measurement.

### Method of Measuring Weight-Average Particle Diameter (D4) of Toner

The weight-average particle diameter (D4) and the number average particle diameter (D1) of the toner are measured by 25,000 effective measuring channels using a precision particle size distribution measuring device “COULTER COUNTER Multisizer 3” (registered trademark, manufactured by Beckman Coulter, Inc.) provided with an aperture tube having a diameter of 100 μm by an aperture impedance method and dedicated software “BECKMAN COULTER Multisizer 3 Version 3.51” (manufactured by Beckman Coulter, Inc.) attached to the device for setting measurement conditions and analyzing measurement data, and calculated by analyzing measurement data.

An electrolyte solution obtained by dissolving special grade sodium chloride in ion exchange water and adjusting the concentration thereof to about 1% by mass, for example, “ISOTON II” (manufactured by Beckman Coulter, Inc.) can be used as the electrolyte solution used for the measurement.

In addition, dedicated software is set up in the following manner before the measurement and the analysis.

In dedicated software “screen for changing standard measuring method (SOM)”, the total count number in the control mode is set to 50,000 particles, the number of times of measurement is set to once, and a value obtained by using “nominal particle 10.0 μm” (manufactured by Beckman Coulter, Inc.) is set as the Kd value. The threshold value and the noise level are automatically set by pressing the measurement button of the threshold value/noise level. Further, the current is set to 1,600 μA, the gain is set to 2, the electrolyte solution is set to ISOTON II, and the aperture tube flash after measurement is checked.

In dedicated software “setting screen for converting pulse to particle diameter”, the bin interval is set to the logarithmic particle diameter, the particle diameter bin is set to 256 particle diameter bin, and the particle diameter range is set to be in a range of 2 μm to 60 μm.

The specific measuring method is as follows.

1. A 250 ml round-bottom glass beaker for exclusive use of Multisizer 3 is charged with about 200 ml of the electrolyte solution and set on a sample stand, and the solution is stirred with a stirrer rod at 24 rotations/see in a counterclockwise direction. Further, the stain and air bubbles inside the aperture tube are removed by the function of the analysis software “aperture tube flash”.
2. A 100 ml flat-bottom glass beaker is charged with about 30 ml of the electrolyte solution, and about 0.3 ml of a diluent obtained by diluting “Contaminon N” (10 mass % aqueous solution of neutral detergent for washing precision measuring machine with pH of 7, which is formed of nonionic surfactant, anionic surfactant, and organic builder, manufactured by FUJIFILM Wako Pure Chemical Corporation) to 3 times by mass with ion exchange water is added thereto as a dispersant.
3. A predetermined amount of ion exchange water is poured into a water tank of an ultrasonic disperser “Ultrasonic Dispersion System Tetoral 150” with an electrical output of 120 W, which is provided with two built-in oscillators having an oscillation frequency of 50 kHz in a state of a phase shift of 180 degrees, and about 2 ml of Contaminon N is added to the water tank.
4. The beaker of the item (2) is set in a beaker fixing hole of the ultrasonic disperser, and the ultrasonic disperser is operated. Further, the position of the height of the beaker is adjusted such that the resonance state of the liquid level of the electrolyte solution in the beaker is maximized.
5. The electrolyte solution in the beaker of the item (4) is irradiated with ultrasonic waves, and about 10 mg of the toner is added to the electrolyte solution little by little and dispersed therein. Further, an ultrasonic dispersion treatment is further continued for 60 seconds. In addition, the water temperature in the water tank is appropriately adjusted to 10° C. or higher and 40° C. or lower in the ultrasonic dispersion treatment.
6. The electrolyte solution of the item (5) in which the toner has been dispersed using a pipette is added dropwise to the round-bottom beaker of the item 1. disposed in the sample stand, and the measurement concentration is adjusted to about 5%.
Further, the measurement is performed until the number of measured particles reaches 50,000.
7. The weight-average particle diameter (D4) and the number average particle diameter (D1) are calculated by analyzing the measurement data using the dedicated software attached to a device. Further, “arithmetic diameter” of the analysis/number statistics (arithmetic average) screen and “arithmetic diameter” of the analysis/volume statistics (arithmetic average) screen are respectively the number average particle diameter (D1) and the weight-average particle diameter (D4) in a case where the graph/number % and the graph/vol % are set with the dedicated software.

### EXAMPLES

Hereinafter, the present disclosure will be described in more detail with reference to examples and comparative examples, but the present disclosure is not limited thereto. Unless otherwise specified, “parts” used in the examples are on a mass basis. Production Example 1 of polyester A
Bisphenol A-ethylene oxide 2-mole adduct (BPA-EO): 27 parts by mole
Bisphenol A-propylene oxide 2-mole adduct (BPA-PO): 73 parts by mole
Isophthalic acid: 100 parts by mole

A flask provided with a stirring device, a nitrogen introduction pipe, a temperature sensor, and a rectifying tower was charged with the above-described monomers and heated to 190° C. for 1 hour, and it was confirmed that the mixture in the reaction system was uniformly stirred. 1.0 parts of tin distearate was added thereto with respect to 100 parts of these monomers. The temperature was increased from 190° C. to 245° C. over 5 hours while water which was further generated was distilled off, and a dehydration condensation reaction was further carried out at 245° C. for 2 hours.

As a result, a polyester resin A-1 having a glass transition temperature of 60.1° C., an acid value of 10 mgKOH/g, a hydroxyl value of 25 mgKOH/g, an Mn of 4,800, and a ratio Mw/Mn of 6.7 was obtained.

### Production Examples 2 to 12 of Polyester A

Each of polyesters A2 to A12 was obtained in the same manner as in Production Example 1 of the polyester A except that the monomer used was changed as listed in Table 1 and the reaction temperature and the time for the dehydration condensation reaction were changed such that the Mn and the ratio Mw/Mn of the obtained polyester A reached desired values. The results are listed in Table 1.

TABLE 1

| | | Poly- | Poly- | Poly- | Poly- | Poly- | Poly- | Poly- | Poly- | Poly- | Poly- | Poly- | Poly- |
|---|---|---|---|---|---|---|---|---|---|---|---|---|---|
| | | ester | ester | ester | ester | ester | ester | ester | ester | ester | ester | ester | ester |
| | | A-1 | A-2 | A-3 | A-4 | A-5 | A-6 | A-7 | A-8 | A-9 | A-10 | A-11 | A-12 |
| Acid | Isophthalic acid | 100 | 100 | 100 | 100 | 100 | 90 | 90 | 90 | 60 | 50 | 90 | 90 |
| component | (parts by mole) | | | | | | | | | | | | |
| | Terephthalic acid | 0 | 0 | 0 | 0 | 0 | 10 | 10 | 10 | 40 | 50 | 10 | 10 |
| | (parts by mole) | | | | | | | | | | | | |
| | Total amount of all | 100 | 100 | 100 | 100 | 100 | 100 | 100 | 100 | 100 | 100 | 100 | 100 |
| | acid components | | | | | | | | | | | | |
| | (parts by mole) | | | | | | | | | | | | |
| Alcohol | BPA EO (parts by | 27 | 27 | 27 | 27 | 27 | 15 | 40 | 5 | 27 | 27 | 55 | 50 |
| component | mole) | | | | | | | | | | | | |
| | BPA-PO (parts by | 73 | 73 | 73 | 63 | 58 | 85 | 60 | 95 | 73 | 73 | 45 | 50 |
| | mole) | | | | | | | | | | | | |
| | Ethylene glycol | 0 | 0 | 0 | 10 | 15 | 0 | 0 | 0 | 0 | 0 | 0 | 0 |
| | (parts by mole) | | | | | | | | | | | | |
| | Total amount of all | 100 | 100 | 100 | 100 | 100 | 100 | 100 | 100 | 100 | 100 | 100 | 100 |
| | alcohol components | | | | | | | | | | | | |
| | (parts by mole) | | | | | | | | | | | | |

| | | | | | | | | | | | | |
|---|---|---|---|---|---|---|---|---|---|---|---|---|
| Mn | 4800 | 8000 | 10000 | 8000 | 3600 | 3500 | 3500 | 3000 | 5000 | 4700 | 4800 | 3000 |
| Mw/Mn | 6.7 | 6.3 | 5.2 | 6.9 | 3.7 | 3.3 | 3.2 | 2.5 | 6.2 | 6.3 | 6.7 | 2.5 |
| Content proportion of unit U [symbol] in | 100 | 100 | 100 | 100 | 100 | 90 | 90 | 90 | 60 | 50 | 90 | 90 |
| all acid components (% by mole) | | | | | | | | | | | | |
| Content proportion of unit U_{EO} | 100 | 100 | 100 | 90 | 85 | 100 | 100 | 100 | 100 | 100 | 100 | 100 |
| and unit U_{PO} in all alcohol | | | | | | | | | | | | |
| components (% by mole) | | | | | | | | | | | | |
| Content proportion of unit U_{PE} in | 27 | 27 | 27 | 30 | 31.8 | 15 | 40 | 5 | 27 | 27 | 55 | 50 |
| total proportion of unit U_{PO} and | | | | | | | | | | | | |
| unit U_{EO} (% by mole) | | | | | | | | | | | | |

[symbol]

indicates data missing or illegible when filed

### Production Example of Styrene Acrylic Resin

Styrene: 77 parts
Butyl acrylate: 23 parts
Di-t-butyl peroxide: 1.0 parts

200 parts of xylene was heated to 200° C., each component was added dropwise to xylene over 4 hours, the mixture was further maintained for 1 hour in xylene reflux, and the polymerization was completed. The physical properties of the obtained styrene acrylic resin are listed in Table 2.

TABLE 2

| | Styrene acrylic resin |
|---|---|
| Styrene (parts) | 77 |
| Butyl acrylate (parts) | 23 |
| Mn | 12000 |
| Mw/Mn | 5.9 |

### Production Example 1 of Crystalline Polyester

1,10-Decanedicarboxylic acid: 100 parts by mole
1,9-Nonanediol: 100 parts by mole
Tine dioctylate as a catalyst: 0.8 parts with respect to total mass of acid alcohol

A heated and dried two-neck flask of a reaction tank equipped with a nitrogen introduction tube, a dehydration tube, a stirrer, and a thermocouple was charged with the above-described materials, nitrogen gas was introduced into the container, and the mixture was maintained in an inert atmosphere and heated while being stirred. Thereafter, the mixture was stirred at 170° C. for 6 hours. Next, the mixture was gradually heated to 230° C. under reduced pressure while being continuously stirred, and further maintained for 3 hours. The mixture was air-cooled when entered in a viscous state, and the reaction was stopped, thereby producing crystalline polyester 1.

The obtained physical properties are listed in Table 3.

### Production Examples 2 and 3 of Crystalline Polyester

Each of crystalline polyester 2 and 3 was obtained in the same manner as described above except that the alcohol monomer and the acid monomer used were changed as listed in Table 3 in Production Example 1 of crystalline polyester. The physical properties of the crystalline polyesters 2 and 3 are listed in Table 3.

TABLE 3

| | Crystalline | Crystalline | Crystalline |
|---|---|---|---|
| | polyester 1 | polyester 2 | polyester 3 |
| Alcohol monomer | 1,9-Nonanediol | 1,12- | 1,12- |
| | | Dodecanediol | Dodecanediol |
| Acid monomer | 1,10- | Sebacic acid | Adipic acid |
| | Decanedicarboxylic | | |
| | acid | | |
| Acid value | 2 | 3 | 4 |
| (mgKOH/g) | | | |
| Melting point | 70 | 80 | 74 |
| (° C.) | | | |
| Mn | 11000 | 10000 | 14000 |
| Mw/Mn | 2.1 | 2.1 | 2.3 |

### Production Examples 1 to 16 of Organic-Inorganic Composite Fine Particles

Organic-inorganic composite fine particles 1 to 16 are produced according to Example 1 of WO2013/063291. Here, methacryloxypropyltrimethoxysilane (hereinafter, abbreviated as MPS) and styrene were used in combination as the monomer forming the resin, and the mixing ratio between MPS and styrene was adjusted such that the ratio P2/P3 reached the value listed in Table 4. Further, the mass ratio between the monomer forming the resin and the silica dispersion liquid was adjusted such that the ratio P2/P1, the silica exposure rate, and the content of the inorganic fine particles (silica fine particles 1 to 3) reached desired values. The physical properties of the organic-inorganic composite fine particles 1 to 16 are listed in Table 4.

TABLE 4

| Organic- | Number average | | | Silica | | | |
|---|---|---|---|---|---|---|---|
| inorganic | particle | | Presence or | exposure | | | Monomer |
| composite fine | diameter D1 | | absence of | rate | | | forming resin |
| particles | (nm) | SF-2 | protrusions | (%) | P2/P1 | P2/P3 | particles |
| 1 | 106 | 115 | Present | 65 | 0.067 | 4.31 | MPS, styrene |
| 2 | 62 | 115 | Present | 58 | 0.077 | 3.35 | MPS, styrene |
| 3 | 55 | 115 | Present | 64 | 0.068 | 4.56 | MPS, styrene |
| 4 | 109 | 115 | Present | 54 | 0.102 | 4.35 | MPS, styrene |
| 5 | 85 | 107 | Present | 50 | 0.107 | 5.29 | MPS, styrene |
| 6 | 159 | 117 | Present | 48 | 0.095 | 5.34 | MPS, styrene |
| 7 | 90 | 107 | Present | 48 | 0.143 | 4.56 | MPS, styrene |
| 8 | 130 | 115 | Present | 45 | 0.176 | 4.20 | MPS, styrene |
| 9 | 185 | 112 | Present | 45 | 0.221 | 5.34 | MPS, styrene |
| 10 | 210 | 117 | Present | 42 | 0.310 | 5.34 | MPS, styrene |
| 11 | 99 | 103 | Present | 42 | 0.183 | 4.77 | MPS, styrene |
| 22 | 97 | 103 | Present | 42 | 0.080 | 0.76 | MPS, styrene |
| 13 | 85 | 115 | Present | 52 | 0.050 | 0.76 | MPS, styrene |
| 14 | 71 | 114 | Present | 63 | 0.031 | 0.76 | MPS, styrene |
| 15 | 71 | 114 | Present | 63 | 0.031 | 0.76 | MPS, styrene |
| 16 | 125 | 103 | Present | 54 | 0 | 0 | Styrene |

| Organic- | Presence of | | Particle | Content of | |
|---|---|---|---|---|---|
| inorganic | absence of | | diameter of | inorganic | Surface |
| composite | ester group | | inorganic fine | fine | treatment of |
| fine | in resin | Inorganic fine | particles | particles | composite fine |
| particles | particles | particles | (nm) | (% by mass) | particles |
| 1 | Present | Silica fine particles 1 | 25 | 66.0 | HMDS |
| 2 | Present | Silica fine particles 2 | 15 | 64.0 | HMDS |
| 3 | Present | Silica fine particles 2 | 15 | 68.0 | HMDS |
| 4 | Present | Silica fine particles 4 | 25 | 56.5 | HMDS |
| 5 | Present | Silica fine particles 2 | 15 | 56.8 | HMDS |
| 6 | Present | Silica fine particles 3 | 50 | 56.0 | HMDS |
| 7 | Present | Silica fine particles 2 | 15 | 54.9 | HMDS |
| 8 | Present | Silica fine particles 1 | 25 | 51.0 | HMDS |
| 9 | Present | Silica fine particles 3 | 50 | 56.0 | HMDS |
| 10 | Present | Silica fine particles 3 | 50 | 56.0 | HMDS |
| 11 | Present | Silica fine particles 2 | 15 | 46.2 | HMDS |
| 22 | Present | Silica fine particles 1 | 25 | 45.0 | HMDS |
| 13 | Present | Silica fine particles 1 | 25 | 56.0 | HMDS |
| 14 | Present | Silica fine particles 1 | 25 | 66.5 | HMDS |
| 15 | Present | Silica fine particles 1 | 25 | 66.5 | HMDS |
| 16 | Absent | Silica fine particles 1 | 25 | 66.5 | HMDS |

### Production Example of Silica Fine Particles 4

In the presence of methanol, water, and ammonia water, when the mixture was heated, tetramethoxysilane was added dropwise thereto while the mixture was stirred, to obtain a suspension of the silica fine particles, the heating temperature, the stirring speed, and the time for dropwise addition were adjusted such that the particle diameter of the silica fine particles obtained was set to the value listed in Table 8. Hexamethyldisilazane as a hydrophobic treatment agent was added at room temperature to the dispersion liquid obtained by replacing the solvent such that the content of hexamethyldisilazane was set to 10 parts with respect to 100 parts of the silica fine particles obtained. Thereafter, the mixture was heated to 120° C. for to cause a reaction, and a hydrophobic treatment was performed on the surface of the silica fine particles.

The mixture was allowed to pass through a wet sieve to remove coarse particles, the solvent was removed, and the resultant was dried, thereby obtaining silica fine particles 4 (sol-gel silica) having a number average particle diameter of 110 nm and an SF-2 value of 1.00.

Preparation of resin particle dispersion liquid of polyester A-1
Polyester A-1:100 parts
Methyl ethyl ketone: 50 parts
Isopropyl alcohol: 20 parts

The methyl ethyl ketone and the isopropyl alcohol were added to a container. Thereafter, the polyester A-1 was gradually added thereto, the mixture was stirred for complete dissolution, thereby obtaining a polyester A-1-dissolved liquid. The temperature of the container containing the polyester A-1-dissolved liquid was set to 65° C., a 10% ammonia aqueous solution was gradually added dropwise to the container so that the total amount of the solution reached 5 parts while the solution was stirred, and 230 parts of ion exchange water was further gradually added dropwise thereto at a rate of 10 ml/min to cause phase inversion emulsification. Further, desolvation was performed under reduced pressure using an evaporator, thereby obtaining a resin particle dispersion liquid 1 of the polyester A-1. The volume average particle diameter of the resin particles contained in the resin particle dissolved-liquid was 130 nm. Further, the solid content of the resin particles was adjusted to 20% with ion exchange water.

### Preparation of Resin Particle Dispersion Liquid of Crystalline Polyester 1

Crystalline polyester 1:100 parts
Methyl ethyl ketone: 50 parts
Isopropyl alcohol: 20 parts

The methyl ethyl ketone and the isopropyl alcohol were added to a container. Thereafter, the crystalline polyester 1 was gradually added thereto, the mixture was stirred for complete dissolution, thereby obtaining a crystalline polyester 1-dissolved liquid. The temperature of the container containing the crystalline polyester 1-dissolved liquid was set to 40° C., a 10% ammonia aqueous solution was gradually added dropwise to the container so that the total amount of the solution reached 3.5 parts while the solution was stirred, and 230 parts of ion exchange water was further gradually added dropwise thereto at a rate of 10 ml/min to cause phase inversion emulsification. Further, desolvation was performed under reduced pressure, thereby obtaining a resin particle dispersion liquid of the crystalline polyester 1. The volume average particle diameter of the resin particles contained in the resin particle dissolved-liquid was 150 nm. Further, the solid content of the resin particles was adjusted to 20% with ion exchange water.

### Preparation of Colorant Particle Dispersion Liquid

Copper phthalocyanine (Pigment Blue 15:3): 45 parts
Sodium dodecylbenzene sulfonate: 5 parts
Ion exchange water: 190 parts

The above-described components were mixed, dispersed for 10 minutes using a homogenizer (ULTRA-TURRAX, manufactured by IKA), and subjected to a dispersion treatment at a pressure of 250 MPa for 20 minutes using an ULTIMIZER (opposition collision type wet pulverizer, manufactured by Sugino Machine Ltd.), thereby obtaining a colorant particle dispersion liquid in which the volume average particle diameter of the colorant particles was 120 nm and the solid content thereof was 20%.

### Preparation of Release Agent Particle Dispersion Liquid

Release agent (hydrocarbon wax, melting point: 79° C.): 15 parts
Sodium dodecylbenzene sulfonate: 2 parts
Ion exchange water: 240 parts

The above-described components were heated to 100° C., sufficiently dispersed with an ULTRA-TURRAX T50 (manufactured by IKA), heated to 115° C. with a pressure discharge type Gaulin homogenizer, and subjected to a dispersion treatment for 1 hour, thereby obtaining a release agent particle dispersion liquid having a volume average particle diameter of 160 nm and a solid content of 20%.

### Production of Toner Particles 1

Resin particle dispersion liquid of polyester A-1:900 parts
Resin particle dispersion liquid of crystalline polyester 1:100 parts
Colorant particle dispersion liquid: 50 parts
Release agent particle dispersion liquid: 80 parts

First, the above-described materials were added to a round stainless steel flask and mixed. Next, the mixture was dispersed using a homogenizer ULTRA-TURRAX T50 (manufactured by IKA) at 5,000 r/min for 10 minutes. A 1.0% nitric acid aqueous solution was added thereto to adjust the pH to 3.0, and an aqueous solution obtained by dissolving 0.50 parts of aluminum chloride (aggregating agent) in 20 parts of ion exchange water was added thereto such that the content of the aluminum element in the toner particles obtained reached a desired value while the mixture was stirred at 30° C. Thereafter, the mixed solution was heated to 58° C. while the rotation speed at which the mixed solution was stirred in a heating water bath using a stirring blade was appropriately adjusted.

The volume average particle diameter of the formed aggregated particles was appropriately confirmed by using COULTER Multisizer III, and in a case where aggregated particles having a diameter of 6.0 μm were formed, the aggregation step was finished.

Thereafter, the pH of the mixture was adjusted to 9.0 by using a 5% sodium hydroxide aqueous solution, continuously stirred, and heated to 92° C. in the spheronization step.

The heating of the mixture was stopped when a desired surface shape was obtained, the mixture was cooled to 40° C. by quickly adding ice thereto in the cooling step such that the cooling rate was set to 10° C./see or greater, and an annealing treatment was performed at 55° C. for 3 hours in the annealing step.

Thereafter, the mixture was cooled to 25° C., filtered, solid-liquid separated, and washed with ion exchange water. After completion of the washing, the mixture was dried using a vacuum dryer, thereby obtaining toner particles 1 having a weight-average particle diameter (D4) of 7.1 μm. The physical properties of the toner particles 1 are listed in Tables 5 and 9.

### Production Examples of Toner Particles 2 to 10, 12 to 36, and 38

Toner particles 2 to 10, 12 to 36, and 38 were obtained by the same method as in the production example of the toner particles 1 except that the combination of materials and the production conditions were changed such that the formulations and the physical properties listed in Tables 5 to 8 were obtained and the kind of the alkylbenzene sulfonate to be added to the colorant particle dispersion liquid and/or the release agent particle dispersion liquid and the amount thereof to be blended were adjusted. The physical properties of the obtained toner particles 2 to 10, 12 to 36, and 38 are listed in Tables 5 to 9.

### Production Example of Toner Particles 11

### Production of Toner Particles by Pulverization Method

The following materials were sufficiently mixed with an FM mixer (manufactured by NIPPON COKE & ENGINEERING CO., LTD.) and melt-kneaded with a twin-screw kneader (manufactured by Ikegai Corp.) set at a temperature of 100° C.
Polyester A-1:90.0 parts
Crystalline polyester 1:10.0 parts
Hydrocarbon wax (melting point: 79° C.): 8.0 parts
C.I. Pigment Blue 15:3:5.0 parts

The obtained kneaded material was cooled and coarsely pulverized to a size of 1 mm or less using a hammer mill, thereby obtaining a coarsely pulverized material.

Next, a finely pulverized material having a size of about 6.5 μm was obtained using a turbo mill (manufactured by FREUNDO-TURBO CORPORATION) from the obtained coarsely pulverized material, and fine and coarse powder was cut out with a multi-division classifier using the Coanda effect, thereby obtaining toner particles 11.

The toner particles 11 had a weight-average particle diameter (D4) of 7.1 μm, a Tg of 58.4° C., and an average circularity of 0.94. The physical properties thereof are listed in Tables 5 and 9.

### Production Example of Toner Particles 37

### Production of Toner Particles Using Suspension Pulverization Method

### Colorant Dispersion Liquid Preparation Step

Styrene: 68 parts
n-Butyl acrylate: 19 parts
C.I. Pigment Blue 15:3:5.0 parts
Negative charge control agent (aluminum compound of dialkylsalicylic acid): 1 part

A colorant dispersion liquid was prepared by dispersing the above-described components with a medium stirring mill using zirconia beads.

### Polymerizable Monomer Composition Preparation Step

Colorant dispersion liquid: 93.0 parts
Polyester A-1:3.0 parts
Crystalline polyester 1:10.0 parts
Hydrocarbon wax (melting point: 79° C.): 8.0 parts
Negative charge control agent (aluminum compound of dialkylsalicylic acid): 1 part

A temperature-adjustable stirring tank was charged with the above-described components, the mixture was heated to 63° C. while being stirred, and further stirred continuously for 45 minutes, thereby obtaining a polymerizable monomer composition.

### Aqueous Medium Preparation Step

Water: 97.8 parts
Na₃PO₄:1.2 parts
10% Hydrochloric acid aqueous solution: 0.3 parts

A different temperature-adjustable stirring tank was charged with the above-described components, and the mixture was stirred until Na₃PO₄ was completely dissolved while the mixture was heated to 60° C.

A solution obtained by dissolving 0.7 parts of CaCl₂) in 5 parts of water was added to the mixture and stirred at a rotation speed of 50 s⁻¹ for 30 minutes using “CLEARMIX” (manufactured by M Technique Co., Ltd.) while the temperature was maintained at 60° C., thereby obtaining an aqueous medium in the form of an aqueous suspension of Ca₃ (PO₄)₂ fine particles.

### Granulation Step

The above-described polymerizable monomer composition was put into the obtained aqueous medium which the aqueous medium was stirred at a rotation speed of 50 s⁻¹ and a temperature of 60° C. using “CLEARMIX” (manufactured by M Technique Co., Ltd.), and the solution was continuously stirred for 3 minutes. Thereafter, 7.0 parts of t-butyl peroxypivalate serving as a polymerization initiator was added thereto with respect to 100 parts of the polymerizable monomer, and the solution was further stirred for 7 minutes, thereby obtaining a polymerizable monomer composition dispersion liquid.

### Polymerization Step

The polymerizable monomer composition dispersion liquid obtained by the above-described step was introduced to a temperature-adjustable stirring tank, the liquid temperature was increased to 67° C., and the solution was polymerized for 5 hours while being stirred, further heated to 80° C., and continuously polymerized for 4 hours, thereby obtaining a polymer fine particle dispersion liquid.

### Volatile Component Removal Step and Cooling Step

A volatile component removal step was performed by introducing the polymer fine particle dispersion liquid obtained in the polymerization step to a stirring tank capable of being heated by steam, blowing steam in the stirring tank through a steam blow-in port, increasing the liquid temperature to 100° C., and stirring the solution for 5 hours.

### Solid-Liquid Separation Step, Washing Step, and Drying Step

Hydrochloric acid was added to the polymer fine particle dispersion liquid, the mixture was stirred so that the Ca₃(PO₄)₂ fine particles covering the polymer fine particles were dissolved. The dissolved liquid was subjected to deliquoring with a pressure filter, water was put into the pressure filter to obtain a dispersion liquid again, and the resulting solution was subjected to deliquoring again with the pressure filter for solid-liquid separation. The solution was washed by repeatedly performing this operation until Ca₃(PO₄)₂ was sufficiently removed. After the solution was washed, the polymer fine particles finally obtained by the solid-liquid separation was sufficiently dried by a known drying unit, thereby obtaining toner particles 37.

When the particle size of the obtained toner particles 37 was measured, the weight-average particle diameter (D4) thereof was 7.1 μm, and the glass transition temperature Tg of the toner particles 37 was 59° C. The physical properties thereof are listed in Tables 8 and 9.

### Production Example of Toner 1

External addition was performed on the toner particles 1. The external addition was performed by adding 20.0 g of the organic-inorganic composite fine particles 1 to 2.0 kg of the toner particles 1 and mixing the mixture with an FM mixer (FM10, manufactured by NIPPON COKE & ENGINEERING CO., LTD.) at 3,000 rpm for 5 minutes. Here, the temperature inside the tank after the mixture was fixed for 5 minutes was adjusted to 35° C. by controlling the temperature and the reuse of cold water flowing in a cooling jacket.

Thereafter, the mixture of the toner particles and the organic-inorganic composite fine particles was allowed to pass through a sieved with a mesh size of 75 μm, thereby obtaining a toner 1. The physical properties of the toner 1 are listed in Table 5.

### Production Examples of Toners 2 to 38

Each of toners 2 to 38 was obtained in the same manner as in the production example of the toner 1 except that the kind of the toner particles and the kind of the organic-inorganic composite fine particles were changed in the production example of the toner 1. The physical properties of the obtained toners 2 to 38 are listed in Tables 5 to 9. Further, the toners 35 and 38 were obtained by adding silica fine particles in place of the organic-inorganic composite fine particles as the external additive.

TABLE 5

| Toner No. | | | 1 | 2 | 3 | 4 | 5 | 6 |
|---|---|---|---|---|---|---|---|---|
| Organic-inorganic composite fine particles | | | 1 | 1 | 1 | 1 | 1 | 1 |
| Toner | Toner particles No. | | 1 | 2 | 3 | 4 | 5 | 6 |
| particles | Polyester A | No. | A-1 | A-1 | A-1 | A-2 | A-3 | A-4 |
| | | Isophthalic acid (parts by mole) | 100 | 100 | 100 | 100 | 100 | 100 |
| | | Terephthalic acid (parts by mole) | 0 | 0 | 0 | 0 | 0 | 0 |
| | | All acid components (parts by mole) | 100 | 100 | 100 | 100 | 100 | 100 |
| | | BPA-EO (parts by mole) | 27 | 27 | 27 | 27 | 27 | 27 |
| | | BPA-PO (parts by mole) | 73 | 73 | 73 | 73 | 73 | 63 |
| | | Ethylene glycol (parts by mole) | 0 | 0 | 0 | 0 | 0 | 10 |
| | | All alcohol components (parts by mole) | 100 | 100 | 100 | 100 | 100 | 100 |
| | | Mn | 4800 | 4800 | 4800 | 8000 | 10000 | 8000 |
| | | Mw/Mn | 6.7 | 6.7 | 6.7 | 6.3 | 5.2 | 6.9 |
| | | Content proportion of unit U [symbol] in all | 100 | 100 | 100 | 100 | 100 | 100 |
| | | acid components (% by mole) | | | | | | |
| | | Content proportion of unit U [symbol] and | 100 | 100 | 100 | 100 | 100 | 90 |
| | | unit U [symbol] in all alcohol components | | | | | | |
| | | (% by mole) | | | | | | |
| | | Content proportion of unit U [symbol] in total | 27 | 27 | 27 | 27 | 27 | 30 |
| | | proportion of unit U [symbol] and unit | | | | | | |
| | | U [symbol] (%by mole) | | | | | | |
| | | Value obtained by dividing ratio P2/P1 | 0.067 | 0.067 | 0.067 | 0.067 | 0.067 | 0.067 |
| | | by content proportion of unit U [symbol] in all | | | | | | |
| | | acid components × 100 | | | | | | |
| | Content of polyester A in binder resin (% by mass) | | 90 | 90 | 90 | 90 | 90 | 90 |
| | Crystalline | No. | 1 | 2 | 3 | 3 | 3 | 1 |
| | polyester | Content of crystalline polyester resin in | 10 | 10 | 10 | 10 | 10 | 10 |
| | | binder resin (% by mass) | | | | | | |
| | Other resins | Type | — | — | — | — | — | — |
| | | Content of other resins in binder resin | — | — | — | — | — | — |
| | | (% by mass) | | | | | | |

| | | | | | | |
|---|---|---|---|---|---|---|
| Average circularity | 0.970 | 0.970 | 0.970 | 0.970 | 0.970 | 0.970 |
| Production method | Emulsion | Emulsion | Emulsion | Emulsion | Emulsion | Emulsion |

| | | | | | |
|---|---|---|---|---|---|
| aggregation | aggregation | aggregation | aggregation | aggregation | aggregation |

| Toner No. | | | 7 | 8 | 9 | 10 | 11 |
|---|---|---|---|---|---|---|---|
| Organic-inorganic composite fine particles | | | 1 | 1 | 1 | 1 | 1 |
| Toner | Toner particles No. | | 7 | 8 | 9 | 10 | 11 |
| particles | Polyester A | No. | A-5 | A-1 | A-1 | A-1 | A-1 |
| | | Isophthalic acid (parts by mole) | 100 | 100 | 100 | 100 | 100 |
| | | Terephthalic acid (parts by mole) | 0 | 0 | 0 | 0 | 0 |
| | | All acid components (parts by mole) | 100 | 100 | 100 | 100 | 100 |
| | | BPA-EO (parts by mole) | 27 | 27 | 27 | 27 | 27 |
| | | BPA-PO (parts by mole) | 58 | 73 | 73 | 73 | 73 |
| | | Ethylene glycol (parts by mole) | 15 | 0 | 0 | 0 | 0 |
| | | All alcohol components (parts by mole) | 100 | 100 | 100 | 100 | 100 |
| | | Mn | 3600 | 4800 | 4800 | 4800 | 4800 |
| | | Mw/Mn | 3.7 | 6.7 | 6.7 | 6.7 | 6.7 |
| | | Content proportion of unit U [symbol] in all | 100 | 100 | 100 | 100 | 100 |
| | | acid components (% by mole) | | | | | |
| | | Content proportion of unit U [symbol] and | 85 | 100 | 100 | 100 | 100 |
| | | unit U [symbol] in all alcohol components | | | | | |
| | | (% by mole) | | | | | |
| | | Content proportion of unit U [symbol] in total | 32 | 27 | 27 | 27 | 27 |
| | | proportion of unit U [symbol] and unit | | | | | |
| | | U [symbol] (%by mole) | | | | | |
| | | Value obtained by dividing ratio P2/P1 | 0.067 | 0.067 | 0.067 | 0.067 | 0.067 |
| | | by content proportion of unit U [symbol] in all | | | | | |
| | | acid components × 100 | | | | | |

| Content of polyester A in binder resin (% by mass) | | 90 | 97 | 85 | 70 | 90 |
|---|---|---|---|---|---|---|
| Crystalline | No. | 1 | 1 | 1 | 1 | 1 |
| polyester | Content of crystalline polyester resin in | 10 | 3 | 15 | 10 | 10 |
| | binder resin (% by mass) | | | | | |
| Other resins | Type | — | — | — | StAc | — |
| | Content of other resins in binder resin | — | — | — | 20 | — |
| | (% by mass) | | | | | |

| | | | | | |
|---|---|---|---|---|---|
| Average circularity | 0.970 | 0.978 | 0.985 | 0.953 | 0.940 |
| Production method | Emulsion | Emulsion | Emulsion | Emulsion | Pulverization |

| | | | |
|---|---|---|---|
| aggregation | aggregation | aggregation | aggregation |

[symbol]

indicates data missing or illegible when filed

TABLE 6

| Toner No. | | | 12 | 13 | 14 | 15 | 16 | 17 |
|---|---|---|---|---|---|---|---|---|
| Organic-inorganic composite fine particles | | | 1 | 1 | 1 | 1 | 1 | 1 |
| Toner | Toner particles No. | | 12 | 13 | 14 | 15 | 16 | 17 |
| particles | Polyester A | No. | A-6 | A-7 | A8 | A-12 | A-1 | A-9 |
| | | Isophthalic acid (parts by mole) | 90 | 90 | 90 | 90 | 100 | 60 |
| | | Terephthalic acid (parts by mole) | 10 | 10 | 10 | 10 | 0 | 40 |
| | | All acid components (parts by mole) | 100 | 100 | 100 | 100 | 100 | 100 |
| | | BPA-EO (parts by mole) | 15 | 40 | 5 | 50 | 27 | 27 |
| | | BPA-PO (parts by mole) | 85 | 60 | 95 | 50 | 73 | 73 |
| | | Ethylene glycol (parts by mole) | 0 | 0 | 0 | 0 | 0 | 0 |
| | | All alcohol components (parts by mole) | 100 | 100 | 100 | 100 | 100 | 100 |
| | | Mn | 3500 | 3500 | 3000 | 3000 | 4800 | 5000 |
| | | Mw/Mn | 3.3 | 3.2 | 2.5 | 2.5 | 6.7 | 6.2 |
| | | Content proportion of unit U [symbol] in all | 90 | 90 | 90 | 90 | 100 | 60 |
| | | acid components (% by mole) | | | | | | |
| | | Content proportion of unit U [symbol] and | 100 | 100 | 100 | 100 | 100 | 100 |
| | | unit U [symbol] in all alcohol components | | | | | | |
| | | (% by mole) | | | | | | |
| | | Content proportion of unit U [symbol] in total | 15 | 40 | 5 | 50 | 27 | 27 |
| | | proportion of unit U [symbol] and unit | | | | | | |
| | | U [symbol] (%by mole) | | | | | | |
| | | Value obtained by dividing ratio P2/P1 | 0.074 | 0.074 | 0.074 | 0.074 | 0.067 | 0.111 |
| | | by content proportion of unit U [symbol] in all | | | | | | |
| | | acid components × 100 | | | | | | |
| | Content of polyester A in binder resin (% by mass) | | 90 | 90 | 90 | 90 | 55 | 90 |
| | Crystalline | No. | 1 | 1 | 1 | 1 | 1 | 1 |
| | polyester | Content of crystalline polyester resin in | 10 | 10 | 10 | 10 | 10 | 10 |
| | | binder resin (% by mass) | | | | | | |
| | Other resins | Type | — | — | — | — | StAc | — |
| | | Content of other resins in binder resin | — | — | — | — | 35 | — |
| | | (% by mass) | | | | | | |

| | | | | | | |
|---|---|---|---|---|---|---|
| Average circularity | 0.970 | 0.970 | 0.970 | 0.970 | 0.970 | 0.970 |
| Production method | Emulsion | Emulsion | Emulsion | Emulsion | Emulsion | Emulsion |

| | | | | | |
|---|---|---|---|---|---|
| aggregation | aggregation | aggregation | aggregation | aggregation | aggregation |

| Toner No. | | | 18 | 19 | 20 | 21 | 22 |
|---|---|---|---|---|---|---|---|
| Organic-inorganic composite fine particles | | | 1 | 1 | 2 | 3 | 4 |
| Toner | Toner particles No. | | 18 | 19 | 20 | 21 | 22 |
| particles | Polyester A | No. | A-1 | A-9 | A-1 | A-1 | A-1 |
| | | Isophthalic acid (parts by mole) | 100 | 60 | 100 | 100 | 100 |
| | | Terephthalic acid (parts by mole) | 0 | 40 | 0 | 0 | 0 |
| | | All acid components (parts by mole) | 100 | 100 | 100 | 100 | 100 |
| | | BPA-EO (parts by mole) | 27 | 27 | 27 | 27 | 27 |
| | | BPA-PO (parts by mole) | 73 | 73 | 73 | 73 | 73 |
| | | Ethylene glycol (parts by mole) | 0 | 0 | 0 | 0 | 0 |
| | | All alcohol components (parts by mole) | 100 | 100 | 100 | 100 | 100 |
| | | Mn | 4800 | 5000 | 4800 | 4800 | 4800 |
| | | Mw/Mn | 6.7 | 6.2 | 6.7 | 6.7 | 6.7 |
| | | Content proportion of unit U [symbol] in all | 100 | 60 | 100 | 100 | 100 |
| | | acid components (% by mole) | | | | | |
| | | Content proportion of unit U [symbol] and | 100 | 100 | 100 | 100 | 100 |
| | | unit U [symbol] in all alcohol components | | | | | |
| | | (% by mole) | | | | | |
| | | Content proportion of unit U [symbol] in total | 27 | 27 | 27 | 27 | 27 |
| | | proportion of unit U [symbol] and unit | | | | | |
| | | U [symbol] (%by mole) | | | | | |
| | | Value obtained by dividing ratio P2/P1 | 0.067 | 0.111 | 0.077 | 0.068 | 0.102 |
| | | by content proportion of unit U [symbol] in all | | | | | |
| | | acid components × 100 | | | | | |

| Content of polyester A in binder resin (% by mass) | | 55 | 100 | 90 | 90 | 90 |
|---|---|---|---|---|---|---|
| Crystalline | No. | — | — | 1 | 1 | 1 |
| polyester | Content of crystalline polyester resin in | — | — | 10 | 10 | 10 |
| | binder resin (% by mass) | | | | | |
| Other resins | Type | StAc | — | — | — | — |
| | Content of other resins in binder resin | 45 | — | — | — | — |
| | (% by mass) | | | | | |

| | | | | | |
|---|---|---|---|---|---|
| Average circularity | 0.970 | 0.970 | 0.970 | 0.970 | 0.970 |
| Production method | Emulsion | Emulsion | Emulsion | Emulsion | Emulsion |

| | | | | |
|---|---|---|---|---|
| aggregation | aggregation | aggregation | aggregation | aggregation |

[symbol]

indicates data missing or illegible when filed

TABLE 7

| Taser No. | | | 23 | 24 | 25 | 26 | 27 | 28 |
|---|---|---|---|---|---|---|---|---|
| Organic-inorganic composite fine particles | | | 5 | 6 | 7 | 8 | 9 | 10 |
| Toner | Toner particles No. | | 23 | 24 | 25 | 26 | 27 | 28 |
| particles | Polyester A | No. | A-1 | A-1 | A-1 | A-1 | A-1 | A-1 |
| | | Isophthalic acid (parts by mole) | 100 | 100 | 100 | 100 | 100 | 100 |
| | | Terephthalic acid (parts by mole) | 0 | 0 | 0 | 0 | 0 | 0 |
| | | All acid components (parts by mole) | 100 | 100 | 100 | 100 | 100 | 100 |
| | | BPA-EO (parts by mole) | 27 | 27 | 27 | 27 | 27 | 27 |
| | | BPA-PO (parts by mole) | 73 | 73 | 73 | 73 | 73 | 73 |
| | | Ethylene glycol (parts by mole) | 0 | 0 | 0 | 0 | 0 | 0 |
| | | All alcohol components (parts by mole) | 100 | 100 | 100 | 100 | 100 | 100 |
| | | Mn | 4800 | 4800 | 4800 | 4800 | 4800 | 4800 |
| | | Mw/Mn | 6.7 | 6.7 | 6.7 | 6.7 | 6.7 | 6.7 |
| | | Content proportion of unit U [symbol] in all | 100 | 100 | 100 | 100 | 100 | 100 |
| | | acid components (% by mole) | | | | | | |
| | | Content proportion of unit U [symbol] and | 100 | 100 | 100 | 100 | 100 | 100 |
| | | unit U [symbol] in all alcohol components | | | | | | |
| | | (% by mole) | | | | | | |
| | | Content proportion of unit U [symbol] in total | 27 | 27 | 27 | 27 | 27 | 27 |
| | | proportion of unit U [symbol] and unit | | | | | | |
| | | U [symbol] (%by mole) | | | | | | |
| | | Value obtained by dividing ratio P2/P1 | 0.107 | 0.095 | 0.143 | 0.176 | 0.221 | 0.310 |
| | | by content proportion of unit U [symbol] in all | | | | | | |
| | | acid components × 100 | | | | | | |
| | Content of polyester A in binder resin (% by mass) | | 90 | 90 | 90 | 90 | 90 | 90 |
| | Crystalline | No. | 1 | 1 | 1 | 1 | 1 | 1 |
| | polyester | Content of crystalline polyester resin in | 10 | 10 | 10 | 10 | 10 | 10 |
| | | binder resin (% by mass) | | | | | | |
| | Other resins | Type | — | — | — | — | — | — |
| | | Content of other resins in binder resin | — | — | — | — | — | — |
| | | (% by mass) | | | | | | |

| | | | | | | |
|---|---|---|---|---|---|---|
| Average circularity | 0.970 | 0.970 | 0.970 | 0.970 | 0.970 | 0.970 |
| Production method | Emulsion | Emulsion | Emulsion | Emulsion | Emulsion | Emulsion |

| | | | | | |
|---|---|---|---|---|---|
| aggregation | aggregation | aggregation | aggregation | aggregation | aggregation |

| Taser No. | | | 29 | 30 | 31 | 32 | 33 |
|---|---|---|---|---|---|---|---|
| Organic-inorganic composite fine particles | | | 11 | 12 | 13 | 14 | 15 |
| Toner | Toner particles No. | | 29 | 30 | 31 | 32 | 33 |
| particles | Polyester A | No. | A-1 | A-1 | A-1 | A-9 | A-1 |
| | | Isophthalic acid (parts by mole) | 100 | 100 | 100 | 60 | 100 |
| | | Terephthalic acid (parts by mole) | 0 | 0 | 0 | 40 | 0 |
| | | All acid components (parts by mole) | 100 | 100 | 100 | 100 | 100 |
| | | BPA-EO (parts by mole) | 27 | 27 | 27 | 27 | 27 |
| | | BPA-PO (parts by mole) | 73 | 73 | 73 | 73 | 73 |
| | | Ethylene glycol (parts by mole) | 0 | 0 | 0 | 0 | 0 |
| | | All alcohol components (parts by mole) | 100 | 100 | 100 | 100 | 100 |
| | | Mn | 4800 | 4800 | 4800 | 5000 | 4800 |
| | | Mw/Mn | 6.7 | 6.7 | 6.7 | 6.2 | 6.7 |
| | | Content proportion of unit U [symbol] in all | 100 | 100 | 100 | 60 | 100 |
| | | acid components (% by mole) | | | | | |
| | | Content proportion of unit U [symbol] and | 100 | 100 | 100 | 100 | 100 |
| | | unit U [symbol] in all alcohol components | | | | | |
| | | (% by mole) | | | | | |
| | | Content proportion of unit U [symbol] in total | 27 | 27 | 27 | 27 | 27 |
| | | proportion of unit U [symbol] and unit | | | | | |
| | | U [symbol] (%by mole) | | | | | |
| | | Value obtained by dividing ratio P2/P1 | 0.183 | 0.080 | 0.050 | 0.051 | 0.031 |
| | | by content proportion of unit U [symbol] in all | | | | | |
| | | acid components × 100 | | | | | |

| Content of polyester A in binder resin (% by mass) | | 90 | 90 | 90 | 90 | 90 |
|---|---|---|---|---|---|---|
| Crystalline | No. | 1 | 1 | 1 | 1 | 1 |
| polyester | Content of crystalline polyester resin in | 10 | 10 | 10 | 10 | 10 |
| | binder resin (% by mass) | | | | | |
| Other resins | Type | — | — | — | — | — |
| | Content of other resins in binder resin | — | — | — | — | — |
| | (% by mass) | | | | | |

| | | | | | |
|---|---|---|---|---|---|
| Average circularity | 0.970 | 0.970 | 0.970 | 0.970 | 0.970 |
| Production method | Emulsion | Emulsion | Emulsion | Emulsion | Emulsion |

| | | | | |
|---|---|---|---|---|
| aggregation | aggregation | aggregation | aggregation | aggregation |

[symbol]

indicates data missing or illegible when filed

TABLE 8

| Toner No. | | | 34 | 35 | 36 | 37 | 38 |
|---|---|---|---|---|---|---|---|
| Organic-inorganic composite fine particles | | | 16 | — | 1 | 1 | — |
| | | | — | Silica fine | — | — | Silica fine |
| | | | | particles 4 | | | particles 4 |
| Toner | Toner particles No. | | 34 | 35 | 36 | 37 | 38 |
| particles | Polyester A | No. | A-1 | A-1 | A-10 | A-1 | A-11 |
| | | Isophthalic acid (parts by mole) | 100 | 100 | 50 | 100 | 90 |
| | | Terephthalic acid (parts by mole) | 0 | 0 | 50 | 0 | 10 |
| | | All acid components (parts by mole) | 100 | 100 | 100 | 100 | 100 |
| | | BPA-EO (parts by mole) | 27 | 27 | 27 | 27 | 55 |
| | | BPA-PO (parts by mole) | 73 | 73 | 73 | 73 | 45 |
| | | Ethylene glycol (parts by mole) | 0 | 0 | 0 | 0 | 0 |
| | | All alcohol components (parts by mole) | 100 | 100 | 100 | 100 | 100 |
| | | Mn | 4800 | 4800 | 4700 | 4800 | 4800 |
| | | Mw/Mn | 6.7 | 6.7 | 6.3 | 6.7 | 6.7 |
| | | Content proportion of unit U [symbol] in all | 100 | 100 | 50 | 100 | 90 |
| | | acid components (% by mole) | | | | | |
| | | Content proportion of unit U_{EO} and unit | 100 | 100 | 100 | 100 | 100 |
| | | U_{PO} in all alcohol components (% by mole) | | | | | |
| | | Content proportion of unit U_{EO} in total | 27 | 27 | 27 | 27 | 55 |
| | | proportion of unit U_{PO} and unit | | | | | |
| | | U_{EO} (%by mole) | | | | | |
| | | Value obtained by dividing ratio P2/P1 | 0 | 0 | 0.133 | 0.067 | 0 |
| | | by content proportion of unit U [symbol] in all | | | | | |
| | | acid components × 100 | | | | | |
| | Content of polyester A in binder resin (% by mass) | | 90 | 90 | 90 | 3 | 90 |
| | Crystalline | No. | 1 | 1 | 1 | 1 | 1 |
| | polyester | Content of crystalline polyester resin in | 10 | 10 | 10 | 10 | 10 |
| | Other resins | binder resin (% by mass) | | | | | |
| | | Type | — | — | — | StAc | — |
| | | Content of other resins in binder resin | — | — | — | 87 | — |
| | | (% by mass) | | | | | |

| | | | | | |
|---|---|---|---|---|---|
| Average circularity | 0.970 | 0.970 | 0.970 | 0.980 | 0.970 |
| Production method | Emulsion | Emulsion | Emulsion | Suspension | Emulsion |

| | | | | |
|---|---|---|---|---|
| aggregation | aggregation | aggregation | polymerization | aggregation |

[symbol]

indicates data missing or illegible when filed

TABLE 9

| | Example 1 | Example 2 | Example 3 | Example 4 | Example 5 | Example 6 | Example 7 | Example 8 | Example 9 | Example 10 |
|---|---|---|---|---|---|---|---|---|---|---|
| | Toner 1 | Toner 2 | Toner 3 | Toner 4 | Toner 5 | Toner 6 | Toner 7 | Toner 8 | Toner 9 | Toner 10 |
| Content of aluminum | 0.002 | 0.01 [symbol] | 0.150 | 0.170 | 0.0 [symbol] 2 | 0.0 [symbol] 2 | 0.0 [symbol] 2 | 0.0 [symbol] 2 | 0.0 [symbol] 2 | 0.0 [symbol] 2 |
| element (% by mass) | | | | | | | | | | |
| Alkylbenzenesulfonic | Sodium | Sodium | Sodium | Sodium | Sodium | Sodium | Sodium | Sodium | Sodium | Sodium |
| acid or [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] |
| Content of | 100 | 20 | 1000 | 100 | 100 | 100 | 100 | 100 | 100 | 100 |
| alkylbenzenesulfonic | | | | | | | | | | |
| acid or [symbol] (ppm) | | | | | | | | | | |

| | Exam- | Exam- | Exam- | Exam- | Exam- | Exam- | Exam- | Exam- | Exam- | Exam- |
|---|---|---|---|---|---|---|---|---|---|---|
| | ple 11 | ple 12 | ple 13 | ple 14 | ple 15 | ple 16 | ple 17 | ple 18 | ple 19 | ple 20 |
| | Toner 11 | Toner 12 | Toner 13 | Toner 14 | Toner 15 | Toner 16 | Toner 17 | Toner 18 | Toner 19 | Toner 20 |
| Content of aluminum | 0 | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 |
| element (% by mass) | | | | | | | | | | |
| Alkylbenzenesulfonic | None | Sodium | Sodium | Sodium | Sodium | Sodium | Sodium | Sodium | Sodium | Sodium |
| acid or [symbol] | | [symbol] | [symbol] | [symbol] | [symbol] | [symbol] | [symbol] | [symbol] | [symbol] | [symbol] |
| | | [symbol] | [symbol] | [symbol] | [symbol] | [symbol] | [symbol] | [symbol] | [symbol] | [symbol] |
| Content of | 0 | 100 | 100 | 100 | 100 | 100 | 100 | 100 | 100 | 100 |
| alkylbenzenesulfonic | | | | | | | | | | |
| acid or [symbol] (ppm) | | | | | | | | | | |
| | Exam- | Exam- | Exam- | Exam- | Exam- | Exam- | Exam- | Exam- | Exam- | Exam- |
| | ple 21 | ple 22 | ple23 | ple24 | ple 25 | ple 26 | ple 27 | ple28 | ple 29 | ple30 |
| | Toner 21 | Toner 22 | Toner 23 | Toner 24 | Toner 25 | Toner 26 | Toner 27 | Toner 28 | Toner 29 | Toner 30 |
| Content of aluminum | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 | 0.0 [symbol] 2 |
| element (% by mass) | | | | | | | | | | |
| Alkylbenzenesulfonic | Sodium | Sodium | Sodium | Sodium | Sodium | Sodium | Sodium | Sodium | Sodium | Sodium |
| acid or [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] |
| Content of | 100 | 100 | 100 | 100 | 100 | 100 | 100 | 100 | 100 | 100 |
| alkylbenzenesulfonic | | | | | | | | | | |
| acid or [symbol] (ppm) | | | | | | | | | | |

| | | | | Comparative | Comparative | Comparative | Comparative | Comparative |
|---|---|---|---|---|---|---|---|---|
| | Example 31 | Example 32 | Example 33 | Example 1 | Example 2 | Example 3 | Example 4 | Example 5 |
| | Toner 31 | Toner 32 | Toner 33 | Toner 34 | Toner 35 | Toner 36 | Toner 37 | Toner 38 |
| Content of aluminum | 0.0 [symbol] 2 | 0.0 [symbol] 2 | 0.0 [symbol] 2 | 0.0 [symbol] 2 | 0.0 [symbol] 2 | 0.0 [symbol] 2 | None | 0.0 [symbol] 2 |
| element (% by mass) | | | | | | | | |
| Alkylbenzenesulfonic | Sodium | Sodium | Sodium | Sodium | Sodium | Sodium | None | Sodium |
| acid or [symbol] | [symbol] | [symbol] | [symbol] | [symbol] | [symbol] | [symbol] | | [symbol] |
| | [symbol] | [symbol] | [symbol] | [symbol] | [symbol] | [symbol] | | [symbol] |
| Content of | 100 | 100 | 100 | 100 | 100 | 100 | 0 | 100 |
| alkylbenzenesulfonic | | | | | | | | |
| acid or [symbol] (ppm) | | | | | | | | |

[symbol]

indicates data missing or illegible when filed

### Example 1

A color laser printer HP LaserJet Enterprise Color M555dn equipped with a one-component toner contact development blade cleaning system and HP212X black toner cartridge (W2120X) CRG, which is a consumable cartridge for the printer were modified and used.

The main body was modified such that the process speed was set to 150% and a printing test could be performed only with a black station. Further, the cartridge was modified such that the capacity of the toner container was increased and the toner container was filled with the toner in the toner filling amount described below, and evaluation was performed. In this manner, the evaluation of the durability with a longer lifetime was performed on the main body operated at a higher speed than in the related art.

### Evaluation 1: Low-Temperature Fixability (Abrasion Density-Decreasing Rate of Halftone Image in Low-Temperature and Low-Humidity (L/L) Environment

The evaluation was performed in a low-temperature and low-humidity environment (a temperature of 15° C. and a relative humidity of 10%), which is a severe environment for the evaluation of low-temperature fixability. The printer main body and the toner cartridge filled with 550 g of the toner (toner 1) were allowed to stand for 24 hours in an environment of 15° C. and 10% RH for the purpose of adjusting the temperature and the humidity in the evaluation environment. COTTON BOND LIGHT COCKLE (basis weight of 90 g/m²), which is rough paper that is likely to be advantageous in terms of the low-temperature fixability due to the unevenness of paper, was used as evaluation paper.

As the evaluation procedures, the density of a halftone image was adjusted such that the image density (measured using a potable spectrophotometer eXact Advanced (manufactured by X-Rite, Inc.)) was set to be in a range of 0.75 to 0.80 at a set temperature of 170° C. from a state in which the entire fixing device was at room temperature, and 10 sheets of images were output.

Thereafter, an image was output at a set temperature of 150° C., and the fixed image was rubbed ten times with lens-cleansing paper to which a load of 5.4 kPa was applied. The density-decreasing rate at 150° C. was calculated from the image densities before and after the rubbing using the following equation.

$$Density - decreasing rate ( \% ) = ( image density before rubbing - image density after rubbing ) \text{} / image density before rubbing \times 100$$

Similarly, the fixing temperature was increased by 5° C. at a time, and the density-decreasing rate was calculated up to a temperature of 200° C.

A relational formula between the fixing temperature and the density-decreasing rate was obtained by performing quadratic polynomial approximation based on the evaluation results of the fixing temperature and the density-decreasing rate obtained from the series of operations. The temperature at which the temperature-decreasing rate reached 15% was calculated using the relational formula, and set as the fixing temperature indicating the threshold for a satisfactory low-temperature fixability.

The low-temperature fixability is satisfactory as the fixing temperature decreases, and the level of C or higher is acceptable in the present disclosure. The evaluation results are listed in Table 10.

Evaluation criteria
A: The fixing temperature was lower than 180° C.
B: The fixing temperature was 180° C. or higher and lower than 190° C.
C: The fixing temperature was 190° C. or higher and lower than 200° C.
D: The fixing temperature was 200° C. or higher.

### Evaluation 2. Anti-Contamination Properties of Charging Roller after Endurance of Double-Sided Printing in Low-Temperature and Low-Humidity Environment (Halftone Density Uniformity)

The printer main body and the toner cartridge filled with 550 g of the toner (toner 1) of Example 1 were allowed to stand for 24 hours in a low-temperature and low-humidity environment of 15° C. and 10% RH for the purpose of adjusting the temperature and the humidity in the evaluation environment. After the standing, durability evaluation was performed by outputting 30,000 sheets of horizontal line images (60,000 images) with a printing ratio of 1.0% and a margin of 5 mm in a double-sided print setting and defining two sheets of double-sided paper as one job using a LETTER size vitality (manufactured by XEROX Corporation, LTR, basis weight of 75 g/m²) in the same low-temperature and low-humidity environment as described above.

Thereafter, the print setting was changed to a single-sided print mode, and a halftone image (halftone image 1) with a printing ratio of 23% and a margin of 5 mm was output as the 30,001st (60,001st image) sheet.

Thereafter, the charging roller was replaced with a new product, and one sheet of a halftone image (halftone image 2) with a printing ratio of 23% was output as the 30,002nd (60,002nd image) sheet.

The image densities of the halftone images 1 and 2 were measured using a potable spectrophotometer eXact Advanced (manufactured by X-Rite, Inc.) at 5 points at intervals of 50 mm from the leading edge of the paper in a longitudinal direction from the leading edge to the trailing edge of the paper for 3 rows, which were the center raw, the raw 20 mm from the left edge, and the raw 20 mm from the right edge, and thus the image densities were measured at a total of 15 points of each image.

A difference in density (difference between the maximum value and the minimum value obtained from the measurement at 15 points) for each of the halftone images 1 and 2 was determined, a difference between the density difference of the halftone image 1 and the density difference in the halftone image 2 was calculated, and a difference in the halftone density due to contamination of the charging roller after the durability evaluation was determined.

When a toner that causes less contamination on the charging roller is used, since a halftone image with the same density difference as in a case of using a new charging roller can be output, the difference in the halftone density due to the contamination of the charging roller after the durability evaluation decreases. Therefore, the evaluation was performed according to the following criteria. The evaluation results are listed in Table 10.

### Evaluation Criteria

A: The difference in the halftone density due to the contamination of the charging roller after the durability evaluation was less than 0.05.
B: The difference in the halftone density due to the contamination of the charging roller after the durability evaluation was 0.05 or greater and less than 0.10.
C: The difference in the halftone density due to the contamination of the charging roller after the durability evaluation was 0.10 or greater and less than 0.15.
D: The difference in the halftone density due to the contamination of the charging roller after the durability evaluation was 0.15 or greater.

### Evaluation 3: Fogging after Endurance of Double-Sided Printing in High-Temperature and High-Humidity (H/H) Environment

The printer main body and the toner cartridge filled with 550 g of the toner (toner 1) of Example 1 were allowed to stand for 24 hours in a high-temperature and high-humidity environment (32.5° C. and 85% RH) for the purpose of adjusting the temperature and the humidity in the evaluation environment. After the standing, durability evaluation was performed by outputting 30,000 sheets of horizontal line images (60,000 images) with a printing ratio of 1.0% and a margin of 5 mm in a double-sided print setting and defining two sheets of double-sided paper as one job using LETTER size vitality (manufactured by XEROX Corporation, LTR, basis weight of 75 g/m²) in the same high-temperature and high-humidity environment as described above.

Thereafter, the print setting was changed to a single-sided print mode, paper formed by attaching a sticky note with a size of 5 cm×5 cm to the central portion of the printing surface of the paper was placed on a cassette, and an all-white image (all-white image 1) was output as the 30,001st (60,001st image).

The sticky note of the all-white image 1 was peeled off, the reflectivity (%) of the portion where the sticky note had been attached and the reflectivity (%) of the portion where the sticky note had not been attached were measured using a white photometer TC-6DX (manufactured by Tokyo Denshoku Co., Ltd.), a difference between the reflectivities was measured and calculated as the fogging (%), and the evaluation was performed according to the following criteria. The evaluation results are listed in Table 10.

### Evaluation Criteria

A: The fogging after the durability evaluation in a high-temperature and high-humidity environment was less than 0.5.
B: The fogging after the durability evaluation in a high-temperature and high-humidity environment was 0.5 or greater and less than 1.0.
C: The fogging after the durability evaluation in a high-temperature and high-humidity environment was 1.0 or greater and less than 1.5.
D: The fogging after the durability evaluation in a high-temperature and high-humidity environment was 1.5 or greater.

### Evaluation 4: Folding Resistance of Line Image in Low-Temperature and Low-Humidity Environment

The evaluation was performed in a low-temperature and low-humidity environment (a temperature of 15° C. and a relative humidity of 10%), which is a severe environment for the evaluation of low-temperature fixability. The printer main body and the toner cartridge filled with 550 g of the toner (toner 1) of Example 1 were allowed to stand for 24 hours in the same low-temperature and low-humidity environment for the purpose of adjusting the temperature and the humidity in the evaluation environment. LETTER size vitality (manufactured by XEROX Corporation, LTR, basis weight of 75 g/m²) was used as evaluation paper.

As the evaluation procedures, 10 sheets of images having 5 horizontal lines at intervals of 5 mm with a line width of 180 μm and a margin of 5 mm from the leading edge at a set temperature of 170° C. from a state in which the entire fixing device was at room temperature was output.

Thereafter, an image was output at a set temperature of 150° C., the central portion of the image was folded such that the image-formed surface was on the inside by a paper feed method, 100 g of a weight was placed on the rear surface of the folded portion, and the image was rubbed with the weight 10 times.

Next, the folded paper was opened again, the fixed image of the folded portion was rubbed 10 times with lens-cleansing paper to which a load of 5.4 kPa was applied. The line width before the rubbing and the line width of the rubbed portion after the rubbing were observed with a loupe, the fixing temperature at which an average of 70% or greater of the line width was maintained with respect to the line width before the rubbing was determined as the fixing temperature with the folding resistance.

Further, the fixing temperature was increased by 5° C. at a time up to 200° C. from 150° C., and the evaluation was performed according to the following criteria. In the present disclosure, the level of C or higher is acceptable in the present disclosure. The evaluation results are listed in Table 10.

### Evaluation Criteria

A: The fixing temperature was lower than 180° C.
B: The fixing temperature was 180° C. or higher and lower than 190° C.
C: The fixing temperature was 190° C. or higher and lower than 200° C.
D: The fixing temperature was 200° C. or higher.

### Evaluation 5: Uniformity of Solid Image in High-Temperature and High-Humidity Environment

The printer main body and the toner cartridge filled with 550 g of the toner (toner 1) of Example 1 were allowed to stand for 24 hours in a high-temperature and high-humidity environment (32.5° C. and 85% RH) for 24 hours for the purpose of adjusting the temperature and the humidity in the evaluation environment. After the standing, durability evaluation was performed by outputting 1,000 sheets of images (2,000 images), in which an all-white image was formed on the first side and a solid image with a margin of 5 mm was formed on the second side in a double-sided print setting, and defining two sheets of double-sided paper as one job using a LETTER size vitality (manufactured by XEROX Corporation, LTR, basis weight of 75 g/m²) in the same low-temperature and low-humidity environment as described above.

Since transferability to paper that had been heated and thickened was required as the transferability of the double-sided image, the evaluation was severe for transferability.

Further, the image densities of the solid image on the second side of the 1,000th sheet of paper were measured using a potable spectrophotometer exact Advanced (manufactured by X-Rite, Inc.) at 5 points at intervals of 50 mm from the leading edge of the paper in a longitudinal direction from the leading edge to the trailing edge of the paper for 3 rows, which were the center raw, the raw 20 mm from the left edge, and the raw 20 mm from the right edge, and thus the image densities were measured at a total of 15 points of the image. The density uniformity of the solid image was determined based on a difference between the maximum value and the minimum value of the image density. The evaluation results are listed in Table 10.

### Evaluation Criteria

A: The difference between the densities of the solid image was less than 0.05.
B: The difference between the densities of the solid image was 0.05 or greater and less than 0.10.
C: The difference between the densities of the solid image was 0.10 or greater and less than 0.15.
D: The difference between the densities of the solid image was 0.15 or greater.

### Evaluation 6. Dot Reproducibility of Halftone Image in Low-Temperature and Low-Humidity Environment

The printer main body and the toner cartridge filled with 550 g of the toner (toner 1) of Example 1 were allowed to stand for 24 hours in a low-temperature and low-humidity environment of 15° C. and 10% RH for 24 hours for the purpose of adjusting the temperature and the humidity in the evaluation environment. LETTER size vitality (manufactured by XEROX Corporation, LTR, basis weight of 75 g/m²) was used as the evaluation paper.

Durability evaluation was performed by outputting 1,000 sheets of images (2,000 images), in which an all-white image was formed on the first side and a halftone image with a printing ratio of 23% and a margin of 5 mm was formed on the second side in a double-sided print setting, and defining two sheets of double-sided paper as one job.

Next, the print main body and the cartridge were allowed to stand 24 hours in the same environment, and the 1,001st sheet of paper, in which an all-white image was formed on the first side and a halftone image with a printing ratio of 23% and a margin of 5 mm was formed on the second side, was output by defining two sheets of double-sided paper as one job.

In terms of the scattering properties of the toner on the image, in a case where an image was output in a state where the printer main body was cooled in a low-temperature and low-humidity environment, the evaluation was severe because other members in contact with the toner were hard and thus the toner was likely to be scattered.

Further, the dot reproducibility was evaluated by confirming the halftone image on the second side of the 1,001st sheet of paper using a loupe and determining the degree of scattered toner particles. The evaluation results are listed in Table 10.

### Evaluation Criteria

A: The percentage of dots with occurrence of scattering was less than 5%.
B: The percentage of dots with occurrence of scattering was 5% or greater and less than 10%.
C: The percentage of dots with occurrence of scattering was 10% or greater and less than 15%.
D: The percentage of dots with occurrence of scattering was 15% or greater.

### Evaluation 7: Streaks on Halftone Image after Endurance of Continuously Printing Solid Image in Low-Temperature and Low-Humidity Environment

The printer main body and the toner cartridge filled with 550 g of the toner (toner 1) of Example 1 were allowed to stand for 24 hours in a low-temperature and low-humidity environment of 15° C. and 10% RH for the purpose of adjusting the temperature and the humidity in the evaluation environment. After the standing, durability evaluation was performed by outputting 500 sheets of paper (1,000 images), in which an all-solid image was formed on the first side and the second side with a printing ratio of 100% and a margin of 5 mm in a double-sided print setting, and defining two sheets of double-sided paper as one job using a LETTER size vitality (manufactured by XEROX Corporation, LTR, basis weight of 75 g/m²) in the same low-temperature and low-humidity environment as described above.

Thereafter, the print setting was changed to a single-sided print mode, and one sheet of a halftone image with a printing ratio of 23% was output as the 501st sheet.

Thereafter, the charging roller was replaced with a new product, and one sheet of a halftone image with a printing ratio of 23% was output as the 502nd sheet.

Further, vertical streaks present on the halftone image of the 501st sheet of paper were compared with vertical streaks present on the halftone image of the 502nd sheet of paper, the number of streaks determined to be the vertical streaks caused by contamination of the charging roller were counted, and evaluation was performed according to the following criteria. The evaluation results are listed in Table 11.

### Evaluation Criteria

A: Vertical streaks were not generated due to the contamination of the charging roller.
B: Vertical streaks were generated due to the contamination of the charging roller, and the number thereof was less than 3.
C: Vertical streaks were generated due to the contamination of the charging roller, and the number thereof was 3 or more and less than 6.
D: Vertical streaks were generated due to the contamination of the charging roller, and the number thereof was 6 or more.

### Evaluation 8. Halftone Density Uniformity after Endurance of Double-Sided Printing of Vertical Band Image in Low-Temperature and Low-Humidity Environment

The printer main body and the toner cartridge filled with 550 g of the toner (toner 1) of Example 1 were allowed to stand for 24 hours in a low-temperature and low-humidity environment of 15° C. and 10% RH for the purpose of adjusting the temperature and the humidity in the evaluation environment. After the standing, durability evaluation was performed by outputting 500 sheets of paper (1,000 images), in which a vertical band image was formed on the first side and the second side with a printing ratio of 50% (all black on the left side of the image and all white on the right side of the image) and a margin of 5 mm in a double-sided print setting, and defining four images and two sheets of double-sided paper as one job using a LETTER size vitality (manufactured by XEROX Corporation, LTR, basis weight of 75 g/m²) in the same low-temperature and low-humidity environment as described above.

Thereafter, the print setting was changed to a single-sided print mode, and one sheet of a halftone image with a printing ratio of 23% was output as the 501st sheet.

Thereafter, the charging roller was replaced with a new product, and one sheet of a halftone image with a printing ratio of 23% was output as the 502nd sheet.

Further, the image densities of the halftone image of the 501st sheet of paper and the halftone image of the 502nd sheet of paper were measured using a potable spectrophotometer exact Advanced (manufactured by X-Rite, Inc.) at 5 points at intervals of 50 mm from the leading edge of the paper in a longitudinal direction from the leading edge to the trailing edge of the paper for 3 rows, which were the center raw, the raw 20 mm from the left edge, and the raw 20 mm from the right edge, and thus the image densities were measured at a total of 15 points of each image.

A difference in density (difference between the maximum value and the minimum value in the measurement at 15 points) was determined for each of the halftone image of the 501st sheet of paper and the halftone image of the 502nd sheet of paper, and a difference between the values of the images was determined.

When a toner that causes less contamination on the charging roller due to endurance of double-sided printing of vertical band images is used, a halftone image with the same density difference as in a case of using a new charging roller can be output. Therefore, it was determined that the difference in the halftone density due to the contamination of the charging roller was large as the difference in density between the charging roller and the new product increased. In the present disclosure, the level of C or higher was acceptable. The evaluation results are listed in Table 11.

### Evaluation Criteria

A: The difference in the halftone density due to the contamination of the charging roller after the durability evaluation was less than 0.05.
B: The difference in the halftone density due to the contamination of the charging roller after the durability evaluation was 0.05 or greater and less than 0.10.
C: The difference in the halftone density due to the contamination of the charging roller after the durability evaluation was 0.10 or greater and less than 0.15.
D: The difference in the halftone density due to the contamination of the charging roller after the durability evaluation was 0.15 or greater.

### Evaluation 9. Difference in Density Between Halftone Areas of Ghost Images after Endurance of Double-Sided Printing in Low-Temperature and Low-Humidity Environment

Durability evaluation was performed in the same manner as in Evaluation 2 by outputting 30,000 sheets (60,000 images) of horizontal line images with a printing ratio of 1.0% and a margin of 5 mm in a double-sided print setting in a low-temperature and low-humidity environment and defining two sheets of double-sided paper as one job.

Thereafter, the charging roller was replaced with a new product, and one sheet of an image (image for ghost evaluation) with a margin of 5 mm from the leading edge, followed by a solid black patch with a size of 10 mm×10 mm, followed by a halftone area with a printing ratio of 23% was output as the 30,001st (60,001st image) sheet.

The densities of the halftone area of the image for ghost evaluation were measured, a difference between the maximum value and the minimum value was determined, and the density difference in the halftone area of the ghost image was determined using a potable spectrophotometer eXact Advanced (manufactured by X-Rite, Inc.).

In a case where the chargeability of the toner was satisfactory, a difference in density between the halftone area corresponding to the cycle of the photoreceptor of the solid black patch and another region was unlikely to occur, and thus the density difference in the halftone area of the ghost image was satisfactory. The evaluation was performed according to the following criteria. The evaluation results are listed in Table 11.

### Evaluation Criteria

A: The density difference in the halftone area of the ghost image was less than 0.05.
B: The density difference in the halftone area of the ghost image was 0.05 or greater and less than 0.10.
C: The density difference in the halftone area of the ghost image was 0.10 or greater and less than 0.15.
D: The density difference in the halftone area of the ghost image was 0.15 or greater.

### Evaluation 10: Fogging after Endurance and Further 7 Days-Standing in High-Temperature and High-Humidity Environment

The printer main body and the toner cartridge filled with 550 g of the toner (toner 1) of Example 1 were allowed to stand for 24 hours in a high-temperature and high-humidity environment (32.5° C. and 85% RH) for the purpose of adjusting the temperature and the humidity in the evaluation environment. After the standing, durability evaluation was performed by outputting 5,000 sheets of horizontal line images (10,000 images) with a printing ratio of 2.0% and a margin of 5 mm in a double-sided print setting and defining two sheets of double-sided paper as one job using LETTER size vitality (manufactured by XEROX Corporation, LTR, basis weight of 75 g/m²) in the same high-temperature and high-humidity environment as described above.

Thereafter, after further standing for 7 days, paper formed by attaching a sticky note with a size of 5 cm×5 cm to the central portion of the printing surface of the paper was placed on a cassette, the print setting was changed to a single-sided print mode, the print setting was changed to a single-sided print mode, and an all-white image (all-white image 1) was output as the 5,001st (10,001st image).

The sticky note of the all-white image 1 was peeled off, the reflectivity (%) of the portion where the sticky note had been attached and the reflectivity (%) of the portion where the sticky note had not been attached were measured using a white photometer TC-6DX (manufactured by Tokyo Denshoku Co., Ltd.), a difference between the reflectivities was measured and calculated as the fogging (%), and the evaluation was performed according to the following criteria. The evaluation results are listed in Table 11.

### Evaluation Criteria

A: The fogging after the durability evaluation in a high-temperature and high-humidity environment was less than 0.5.
B: The fogging after the durability evaluation in a high-temperature and high-humidity environment was 0.5 or greater and less than 1.0.
C: The fogging after the durability evaluation in a high-temperature and high-humidity environment was 1.0 or greater and less than 1.5.
D: The fogging after the durability evaluation in a high-temperature and high-humidity environment was 1.5 or greater.

### Evaluation 11. Halftone Density Uniformity after Endurance of Double-Sided Printing in Extremely Low-Temperature and Low-Humidity Environment

The printer main body and the toner cartridge filled with 550 g of the toner (toner 1) of Example 1 were allowed to stand for 24 hours in a low-temperature and low-humidity environment of 5° C. and 10% RH for the purpose of adjusting the temperature and the humidity in the evaluation environment. After the standing, durability evaluation was performed by outputting 10,000 sheets of paper (20,000 images), in which a horizontal line image was formed on the first side and the second side with a printing ratio of 1% in a double-sided print setting, and defining two sheets of double-sided paper as one job using a LETTER size vitality (manufactured by XEROX Corporation, LTR, basis weight of 75 g/m²) in the same extremely low-temperature and low-humidity environment as described above.

Thereafter, the print setting was changed to a single-sided print mode, and one sheet of a halftone image with a printing ratio of 23% was output as the 10,001st sheet.

Thereafter, the charging roller was replaced with a new product, and one sheet of a halftone image with a printing ratio of 23% was output as the 10,002nd sheet.

Further, the image densities of the halftone image of the 10,001st sheet of paper and the halftone image of the 10,002nd sheet of paper were measured using a potable spectrophotometer eXact Advanced (manufactured by X-Rite, Inc.) at 5 points at intervals of 50 mm from the leading edge of the paper in a longitudinal direction from the leading edge to the trailing edge of the paper for 3 rows, which were the center raw, the raw 20 mm from the left edge, and the raw 20 mm from the right edge, and thus the image densities were measured at a total of 15 points of the image.

Further, a difference in density (difference between the maximum value and the minimum value in the measurement at 15 points) was determined for each of the halftone image of the 10,001st sheet of paper and the halftone image of the 10,002nd sheet of paper, and a difference between the values of the images was determined.

When a toner that causes less contamination on the charging roller due to endurance of double-sided printing is used, a halftone image with the same density difference as in a case of using a new charging roller can be output. Therefore, it was determined that the difference in the halftone density due to the contamination of the charging roller was large as the difference in density between the charging roller and the new product increased. In the present disclosure, the level of C or higher was acceptable. The evaluation results are listed in Table 11.

### Evaluation Criteria

A: The difference in the halftone density due to the contamination of the charging roller after the durability evaluation was less than 0.05.
B: The difference in the halftone density due to the contamination of the charging roller after the durability evaluation was 0.05 or greater and less than 0.10.
C: The difference in the halftone density due to the contamination of the charging roller after the durability evaluation was 0.10 or greater and less than 0.15.
D: The difference in the halftone density due to the contamination of the charging roller after the durability evaluation was 0.15 or greater.

### Evaluation 12. Line Width Uniformity after Endurance of Double-Sided Printing in Low-Temperature and Low-Humidity Environment

Durability evaluation was performed in the same manner as in Evaluation 2 by outputting 30,000 sheets (60,000 images) of horizontal line images with a printing ratio of 1.0% and a margin of 5 mm in a double-sided print setting in a low-temperature and low-humidity environment and defining two sheets of double-sided paper as one job.

Thereafter, the charging roller was replaced with a new product, and one sheet of a horizontal line image in which ten four-dot horizontal lines were spaced at intervals of 5 mm with a margin of 5 mm from the leading edge was output as the 30,001st (60,001st image) sheet.

The line widths of the horizontal line image were measured using a loupe, and a difference between the maximum value and the minimum value was determined. The line width stability was more satisfactory as the difference in line width decreased. The evaluation results are listed in Table 11.

### Evaluation Criteria

A: The difference in line width was less than 5 μm.
B: The difference in line width was 5 μm or greater and less than 10 μm. C: The difference in line width was 10 μm or greater and less than 15 μm.
D: The difference in line width was 15 μm or greater.

### Evaluation 13. Line Width Uniformity of Vertical Thin Line Image in Low-Temperature and Low-Humidity Environment

Durability evaluation was performed in the same manner as in Evaluation 2 by outputting 30,000 sheets (60,000 images) of horizontal line images with a printing ratio of 1.0% and a margin of 5 mm in a double-sided print setting in a low-temperature and low-humidity environment of 15° C. and 10% RH and defining two sheets of double-sided paper as one job.

Thereafter, the charging roller was replaced with a new product, and one sheet of a vertical line image in which ten four-dot vertical lines were spaced at intervals of 5 mm with a margin of 5 mm from the leading edge was output as the 30,001st (60,001st image) sheet.

The line widths of the vertical line image were measured using a loupe, and a difference between the maximum value and the minimum value was determined. The line width stability was more satisfactory as the difference in line width decreased. The evaluation results are listed in Table 12.

### Evaluation Criteria

A: The difference in line width was less than 5 μm.
B: The difference in line width was 5 μm or greater and less than 10 μm.
C: The difference in line width was 10 μm or greater and less than 15 μm.
D: The difference in line width was 15 μm or greater.

### Evaluation 14. Line Width Uniformity of Vertical Thin Line Image in High-Temperature and High-Humidity Environment

Durability evaluation was performed in the same manner as in Evaluation 3 by outputting 30,000 sheets (60,000 images) of horizontal line images with a printing ratio of 1.0% and a margin of 5 mm in a double-sided print setting in a high-temperature and high-humidity environment of 32.5° C. and 85% RH and defining two sheets of double-sided paper as one job.

Thereafter, the charging roller was replaced with a new product, and one sheet of a vertical line image in which ten four-dot vertical lines were spaced at intervals of 5 mm with a margin of 5 mm from the leading edge was output as the 30,001st (60,001st image) sheet.

The line widths of the vertical line image were measured using a loupe, and a difference between the maximum value and the minimum value was determined. The line width stability was more satisfactory as the difference in line width decreased. The evaluation results are listed in Table 12.

### Evaluation Criteria

A: The difference in line width was less than 5 μm.
B: The difference in line width was 5 μm or greater and less than 10 μm.
C: The difference in line width was 10 μm or greater and less than 15 μm.
D: The difference in line width was 15 μm or greater.

### Examples 2 to 33 and Comparative Examples 1 to 5

The evaluation was performed in the same manner as in Example 1 except that the evaluation toner was changed to toners 2 to 33 and 34 to 38. The evaluation results of Examples 2 to 33 and Comparative Examples 1 to 5 are listed in Tables 10 to 12.

TABLE 10

| | | | | Evaluation 2 | | | | | | | | | |
|---|---|---|---|---|---|---|---|---|---|---|---|---|---|
| | | Evaluation 1 | | Anti-contamination | | | | | | | | | |
| | | Low-temperature | | properties of | | | | | | | | | |
| | | fixability of | | charging roller after | | Evaluation 3 | | Evaluation 4 | | | | Evaluation 6 | |
| | | halftone | | endurance of double- | | Fogging after | | Folding | | Evaluation 5 | | Dot | |
| | | image in L/L | | sided printing in L/L | | endurance of | | resistance | | Uniformity | | reproducibility | |
| | | (abrasion density- | | (halftone density | | double-sided | | of line | | of solid | | of halftone | |
| Example No. | Toner No. | decreasing rate) | | uniformity) | | printing in H/H | | image in L/L | | image in H/H | | image in L/L | |
| Example 1 | 1 | A | 155 | A | 0.02 | A | 0.1 | A | 160 | A | 0.03 | A | 1 |
| Example 2 | 2 | A | 155 | A | 0.02 | A | 0.1 | A | 160 | A | 0.03 | A | 2 |
| Example 3 | 3 | A | 155 | A | 0.02 | A | 0.1 | A | 160 | A | 0.03 | A | 2 |
| Example 4 | 4 | A | 165 | A | 0.02 | A | 0.1 | A | 170 | A | 0.03 | A | 2 |
| Example 5 | 5 | A | 175 | A | 0.03 | A | 0.2 | B | 180 | A | 0.03 | A | 3 |
| Example 6 | 6 | A | 170 | A | 0.03 | A | 0.2 | B | 180 | A | 0.03 | A | 3 |
| Example 7 | 7 | A | 175 | A | 0.04 | A | 0.3 | C | 190 | A | 0.03 | A | 4 |
| Example 8 | 8 | A | 165 | A | 0.03 | A | 0.2 | A | 170 | A | 0.03 | B | 6 |
| Example 9 | 9 | A | 155 | A | 0.04 | A | 0.3 | A | 160 | A | 0.03 | C | 12 |
| Example 10 | 10 | A | 170 | A | 0.03 | A | 0.2 | A | 175 | B | 0.07 | A | 3 |
| Example 11 | 11 | A | 160 | A | 0.04 | A | 0.3 | A | 170 | C | 0.11 | A | 4 |
| Example 12 | 12 | A | 155 | A | 0.03 | B | 0.5 | A | 160 | A | 0.04 | A | 3 |
| Example 13 | 13 | A | 155 | A | 0.03 | B | 0.5 | A | 160 | A | 0.04 | A | 3 |
| Example 14 | 14 | A | 155 | A | 0.04 | C | 1.0 | A | 160 | A | 0.04 | A | 4 |
| Example 15 | 15 | A | 155 | A | 0.04 | C | 1.0 | A | 160 | A | 0.04 | A | 4 |
| Example 16 | 16 | B | 180 | B | 0.05 | A | 0.3 | A | 170 | A | 0.04 | A | 3 |
| Example 17 | 17 | B | 180 | B | 0.05 | A | 0.3 | A | 170 | A | 0.04 | A | 3 |
| Example 18 | 18 | C | 190 | B | 0.07 | A | 0.3 | A | 175 | A | 0.04 | A | 4 |
| Example 19 | 19 | C | 190 | B | 0.07 | A | 0.3 | A | 175 | A | 0.04 | A | 4 |
| Example 20 | 20 | A | 155 | A | 0.03 | A | 0.3 | A | 160 | A | 0.03 | A | 2 |
| Example 21 | 21 | A | 155 | A | 0.02 | A | 0.1 | A | 160 | A | 0.03 | A | 2 |
| Example 22 | 22 | A | 155 | A | 0.02 | A | 0.1 | A | 160 | A | 0.03 | A | 2 |
| Example 23 | 23 | A | 155 | A | 0.02 | A | 0.1 | A | 160 | A | 0.03 | A | 2 |
| Example 24 | 24 | A | 155 | A | 0.03 | A | 0.3 | A | 160 | A | 0.03 | A | 2 |
| Example 25 | 25 | A | 155 | A | 0.03 | A | 0.3 | A | 160 | A | 0.03 | A | 2 |
| Example 26 | 26 | A | 155 | A | 0.04 | A | 0.4 | A | 160 | A | 0.03 | A | 2 |
| Example 27 | 27 | A | 155 | A | 0.04 | A | 0.4 | A | 160 | A | 0.03 | A | 2 |
| Example 28 | 28 | A | 155 | A | 0.04 | A | 0.4 | A | 160 | A | 0..04 | A | 4 |
| Example 29 | 29 | A | 155 | A | 0.04 | A | 0.4 | A | 160 | A | 0..04 | A | 3 |
| Example 30 | 30 | A | 155 | A | 0.04 | A | 0.4 | A | 160 | A | 0..04 | A | 3 |
| Example 31 | 31 | A | 155 | A | 0.04 | A | 0.4 | A | 160 | A | 0.03 | A | 4 |
| Example 32 | 32 | B | 180 | B | 0.08 | A | 0.4 | A | 170 | A | 0.04 | A | 4 |
| Example 33 | 33 | A | 160 | A | 0.04 | A | 0.4 | A | 160 | A | 0.03 | A | 4 |
| Comparative Example 1 | 34 | B | 185 | D | 0.19 | D | 1.9 | C | 195 | C | 0.13 | C | 14 |
| Comparative Example 2 | 35 | B | 185 | D | 0.25 | D | 2.1 | C | 195 | D | 0.19 | C | 14 |
| Comparative Example 3 | 36 | D | 205 | D | 0.22 | C | 1.4 | D | 205 | C | 0.14 | C | 14 |
| Comparative Example 4 | 37 | D | 205 | D | 0.23 | C | 1.4 | D | 205 | B | 0.09 | D | 20 |
| Comparative Example 5 | 38 | B | 185 | D | 0.28 | D | 2.4 | C | 195 | D | 0.21 | C | 14 |

TABLE 11

| | | Evaluation 7 | | Evaluation 8 | | Evaluation 9 | | | | | | | |
|---|---|---|---|---|---|---|---|---|---|---|---|---|---|
| | | Streaks on | | Halftone density | | Difference in | | | | | | | |
| | | halftone | | uniformity after | | density between | | | | Evaluation 11 | | Evaluation 12 | |
| | | image after | | endurance of | | halftone areas | | Evaluation 10 | | Halftone density | | Line width | |
| | | endurance of | | double-sided | | of ghost images | | Fogging after | | uniformity after | | uniformity after | |
| | | continuously | | printing of | | after endurance | | endurance | | endurance of double- | | endurance of | |
| | | printing solid | | vertical band | | of double-sided | | and standing | | sided printing | | double-sided | |
| Example No. | Toner No. | image in L/L | | image in L/L | | printing in L/L | | in H/H | | in extreme L/L | | printing in L/L | |
| Example 1 | Toner 1 | A | 0 | A | 0.02 | A | 0.01 | A | 0.1 | A | 0.02 | A | 2 |
| Example 2 | Toner 2 | A | 0 | A | 0.02 | A | 0.01 | A | 0.1 | A | 0.02 | A | 2 |
| Example 3 | Toner 3 | A | 0 | A | 0.02 | A | 0.02 | A | 0.1 | A | 0.02 | A | 2 |
| Example 4 | Toner 4 | A | 0 | A | 0.02 | A | 0.01 | A | 0.1 | A | 0.02 | A | 2 |
| Example 5 | Toner 5 | A | 0 | A | 0.02 | A | 0.02 | A | 0.2 | A | 0.02 | A | 3 |
| Example 6 | Toner 6 | A | 0 | A | 0.02 | A | 0.01 | A | 0.2 | A | 0.02 | A | 3 |
| Example 7 | Toner 7 | A | 0 | A | 0.02 | A | 0.02 | A | 0.2 | A | 0.03 | A | 4 |
| Example 8 | Toner 8 | A | 0 | A | 0.02 | A | 0.02 | A | 0.2 | A | 0.02 | A | 3 |
| Example 9 | Toner 9 | A | 0 | A | 0.02 | A | 0.01 | A | 0.2 | A | 0.03 | A | 4 |
| Example 10 | Toner 10 | A | 0 | A | 0.02 | A | 0.02 | A | 0.2 | A | 0.02 | A | 3 |
| Example 11 | Toner 11 | A | 0 | A | 0.02 | A | 0.01 | A | 0.2 | A | 0.03 | A | 4 |
| Example 12 | Toner 12 | A | 0 | A | 0.02 | A | 0.02 | A | 0.3 | A | 0.02 | A | 3 |
| Example 13 | Toner 13 | A | 0 | A | 0.02 | A | 0.01 | A | 0.3 | A | 0.02 | A | 3 |
| Example 14 | Toner 14 | A | 0 | A | 0.02 | A | 0.02 | A | 0.4 | A | 0.03 | A | 4 |
| Example 15 | Toner 15 | A | 0 | A | 0.02 | A | 0.02 | A | 0.4 | A | 0.03 | A | 4 |
| Example 16 | Toner 16 | A | 0 | B | 0.05 | B | 0.06 | A | 0.2 | B | 0.06 | A | 3 |
| Example 17 | Toner 17 | A | 0 | B | 0.05 | B | 0.05 | A | 0.2 | B | 0.07 | A | 3 |
| Example 18 | Toner 18 | A | 0 | B | 0.05 | B | 0.06 | A | 0.2 | B | 0.06 | A | 4 |
| Example 19 | Toner 19 | A | 0 | B | 0.05 | B | 0.06 | A | 0.2 | B | 0.07 | A | 4 |
| Example 20 | Toner 20 | A | 0 | A | 0.03 | A | 0.02 | A | 0.2 | A | 0.03 | B | 8 |
| Example 21 | Toner 21 | A | 0 | A | 0.02 | A | 0.02 | A | 0.1 | A | 0.02 | A | 3 |
| Example 22 | Toner 22 | A | 0 | A | 0.02 | A | 0.02 | A | 0.1 | A | 0.02 | A | 3 |
| Example 23 | Toner 23 | A | 0 | A | 0.02 | A | 0.02 | A | 0.2 | A | 0.02 | A | 3 |
| Example 24 | Toner 24 | A | 0 | A | 0.02 | A | 0.03 | B | 0.7 | A | 0.02 | A | 3 |
| Example 25 | Toner 25 | A | 0 | A | 0.02 | B | 0.08 | B | 0.8 | A | 0.02 | A | 3 |
| Example 26 | Toner 26 | A | 0 | A | 0.02 | C | 0.12 | B | 0.9 | A | 0.02 | A | 4 |
| Example 27 | Toner 27 | A | 0 | A | 0.02 | C | 0.12 | B | 0.9 | A | 0.02 | A | 4 |
| Example 28 | Toner 28 | C | 3 | A | 0.04 | C | 0.13 | C | 1.3 | A | 0.02 | A | 4 |
| Example 29 | Toner 29 | B | 1 | A | 0.03 | C | 0.12 | C | 1.3 | A | 0.02 | A | 4 |
| Example 30 | Toner 30 | B | 1 | A | 0.03 | A | 0.03 | C | 1.3 | A | 0.02 | C | 10 |
| Example 31 | Toner 31 | A | 0 | B | 0.08 | A | 0.03 | A | 0.3 | B | 0.06 | C | 11 |
| Example 32 | Toner 32 | A | 0 | C | 0.14 | B | 0.09 | A | 0.4 | B | 0.09 | C | 12 |
| Example 33 | Toner 33 | A | 0 | C | 0.12 | A | 0.04 | A | 0.4 | C | 0.12 | C | 12 |
| Comparative Example 1 | Toner 34 | D | 10 | D | 0.20 | D | 0.21 | D | 1.8 | D | 0.19 | D | 18 |
| Comparative Example 2 | Toner 35 | D | 17 | D | 0.25 | D | 0.24 | D | 2.5 | D | 0.22 | D | 24 |
| Comparative Example 3 | Toner 36 | D | 10 | D | 0.20 | D | 0.19 | C | 1.4 | D | 0.20 | C | 14 |
| Comparative Example 4 | Toner 37 | D | 10 | D | 0.20 | D | 0.19 | C | 1.4 | D | 0.19 | C | 14 |
| Comparative Example 5 | Toner 38 | D | 15 | D | 0.26 | D | 0.25 | D | 2.4 | D | 0.23 | D | 23 |

TABLE 12

| | | | | Evaluation 14 | |
|---|---|---|---|---|---|
| | | | | Line width uniformity of | |
| | | Evaluation 13 | | thin vertical line image in | |
| | | Line width uniformity of | | high-temperature and | |
| | Toner | thin vertical line image in | | high-humidity | |
| Example No. | No. | L/L | | environment | |
| Example 1 | 1 | A | 2 | A | 3 |
| Example 2 | 2 | B | 7 | B | 7 |
| Example 3 | 3 | B | 8 | B | 8 |
| Example 4 | 4 | C | 10 | B | 8 |
| Example 5 | 5 | A | 2 | A | 3 |
| Example 6 | 6 | A | 3 | A | 3 |
| Example 7 | 7 | A | 2 | A | 2 |
| Example 8 | 8 | A | 3 | A | 4 |
| Example 9 | 9 | A | 3 | A | 3 |
| Example 10 | 10 | A | 4 | A | 2 |
| Example 11 | 11 | C | 12 | C | 13 |
| Example 12 | 12 | A | 3 | A | 4 |
| Example 13 | 13 | A | 2 | A | 2 |
| Example 14 | 14 | A | 2 | A | 3 |
| Example 15 | 15 | A | 3 | A | 2 |
| Example 16 | 16 | A | 2 | A | 4 |
| Example 17 | 17 | A | 3 | A | 2 |
| Example 18 | 18 | A | 3 | A | 3 |
| Example 19 | 19 | A | 4 | A | 2 |
| Example 20 | 20 | A | 2 | A | 2 |
| Example 21 | 21 | A | 2 | A | 4 |
| Example 22 | 22 | A | 3 | A | 2 |
| Example 23 | 23 | A | 2 | A | 3 |
| Example 24 | 24 | A | 3 | A | 4 |
| Example 25 | 25 | A | 3 | A | 2 |
| Example 26 | 26 | A | 4 | A | 3 |
| Example 27 | 27 | A | 2 | A | 3 |
| Example 28 | 28 | A | 2 | A | 2 |
| Example 29 | 29 | A | 3 | A | 3 |
| Example 30 | 30 | A | 2 | A | 2 |
| Example 31 | 31 | A | 3 | A | 2 |
| Example 32 | 32 | A | 3 | A | 3 |
| Example 33 | 33 | A | 3 | A | 3 |
| Comparative | 34 | B | 9 | B | 9 |
| Example 1 | | | | | |
| Comparative | 35 | B | 9 | B | 9 |
| Example 2 | | | | | |
| Comparative | 36 | B | 9 | B | 8 |
| Example 3 | | | | | |
| Comparative | 37 | D | 16 | D | 20 |
| Example 4 | | | | | |
| Comparative | 38 | B | 9 | B | 9 |
| Example 5 | | | | | |

According to the present disclosure, both the low-temperature fixability of the toner and the anti-contamination properties of the charging member can be achieved. Therefore, it is possible to provide a toner that has satisfactory density uniformity of a halftone image and also has satisfactory low-temperature fixability (abrasion density-decreasing rate) even in a case where an image forming apparatus employing a one-component contact developing system is used for a long period of time in a low-temperature and low-humidity environment in a mode in which double-sided images are output at a high frequency, which is susceptible to toner deterioration and contamination of the charging member.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-209210, filed Dec. 2, 2024, and Japanese Patent Application No. 2023-219457, filed Dec. 26, 2023, each of which is hereby incorporated by reference herein in their entirety.

What is claimed is:

1. A toner comprising:
a toner particle that contains a binder resin; and
an organic-inorganic composite fine particle,
wherein the binder resin contains 50% by mass or greater of polyester A,
a content proportion of a unit Uᵢₛₒ derived from isophthalic acid in the polyester A is 60% by mole or greater with respect to an amount of all units derived from an acid component,
the organic-inorganic composite fine particle has, on a surface of a resin particle, a plurality of protrusions derived from an inorganic fine particle,
the inorganic fine particle includes a silica fine particle, and
the resin particle contains an ester group.

2. The toner according to claim 1,
wherein a content proportion of the unit Uᵢₛₒ in the polyester A is 90% by mole or greater.

3. The toner according to claim 1,
wherein the polyester A has a unit U_{EO} derived from an ethylene oxide adduct of bisphenol A and a unit U_{PO} derived from a propylene oxide adduct of bisphenol A, and
a total content proportion of the unit U_{EO} and the unit U_{PO} is 90% by mole or greater with respect to an amount of all units derived from an alcohol component.

4. The toner according to claim 3,
wherein a content proportion of the unit U_{EO} is 15% by mole or greater and 40% by mole or less with respect to the total content proportion of the unit U_{EO} and the unit U_{PO}.

5. The toner according to claim 1,
wherein when a number average molecular weight (Mn) and a weight-average molecular weight (Mw) of tetrahydrofuran (THF) soluble matter of the polyester A are measured using gel permeation chromatography (GPC), the number average molecular weight (Mn) is 3,000 or greater and 10,000 or less, and a ratio (Mw/Mn) is 2.5 or greater.

6. The toner according to claim 1,
wherein the binder resin contains crystalline polyester.

7. The toner according to claim 1,
having an average circularity of 0.950 or greater and 0.980 or less.

8. The toner according to claim 1,
wherein the organic-inorganic composite fine particle has a number average particle diameter (D1) of 50 nm or greater and 200 nm or less, and
the organic-inorganic composite fine particle has a shape factor SF-2 of 103 or greater and 120 or less as measured at a magnification of 200,000 times.

9. The toner according to claim 1,
wherein a ratio P2/P1 of an intensity P2 of a peak derived from C═O to an intensity P1 of a peak derived from Si—O, which is obtained by ATR-IR of the organic-inorganic composite fine particle, is 0.05 or greater and 0.15 or less.

10. The toner according to claim 9,
wherein a value obtained by dividing the ratio P2/P1 by the content proportion of the unit Uᵢₛₒ and multiplying the obtained value by 100 is 0.05 or greater.

11. The toner according to claim 1,
wherein a surface exposure rate B of silica in the organic-inorganic composite fine particle as measured by X-ray photoelectron spectroscopic analysis is 45% or greater.

12. The toner according to claim 1,
wherein when an intensity P3 of a peak derived from a styrene unit and an intensity P2 of a peak derived from C═O are obtained in ATR-IR measurement of the organic-inorganic composite fine particle, a ratio P2/P3 is 1.0 or greater.

13. The toner according to claim 1,
containing 0.015% by mass or greater and 0.150% by mass or less of an aluminum element.

14. The toner according to claim 1,
containing at least one compound selected from the group consisting of alkylbenzenesulfonic acid and an alkylbenzene sulfonate.
